(19) United States
(12) Patent Application Publication
(10) Pub. No.: US 2024/0251834 A1
(43) Pub. Date: Aug. 1, 2024

(54) CONSUMABLES INFUSED WITH COMPOUNDS FROM CANNABIS, NATURALLYOCCURRING SUBSTANCES, AND MUSHROOMS

(71) Applicant: TLCO Holdings Inc., PLAYA DEL REY, CA (US)

(72) Inventor: Michael William Randel, Lakebay, WA (US)

(73) Assignee: TLCO Holdings Inc., PLAYA DEL REY, CA (US)

(21) Appl. No.: 18/425,334

(22) Filed: Jan. 29, 2024

Related U.S. Application Data
(60) Provisional application No. 63/441,829, filed on Jan. 29, 2023.

(51) Int. Cl. A23L 29/00; A23D 7/005; A23L 31/00

(52) U.S. Cl. CPC A23L 29/035; A23D 9/007; A23L 31/00

(57) ABSTRACT

Consumables infused with compounds from cannabis, naturally-occurring substances and mushrooms and a method of production are disclosed. The method includes obtaining a food grade oil, cannabis, a mushroom compound and a naturally-occurring substance, infusing the food grade oil with the cannabis, the mushroom compound and the naturally-occurring substance, combining the whole spectrum cannabis compounds infused food grade oil with the whole spectrum naturally-occurring substance infused food grade oil and the whole spectrum mushroom compounds infused food grade oil to yield a combined food grade oil and infusing at least one orally ingestible consumable with the combined food grade oil.

### CROSS-REFERENCE TO RELATED APPLICATIONS

This application claims the benefit of priority of U.S. Provisional Patent Application Ser. No. 63/441,829, filed on Jan. 29, 2023, and titled “CONSUMABLES INFUSED WITH COMPOUNDS FROM CANNABIS, OTHER NATURALLY OCCURRING SUBSTANCES, AND MUSHROOMS,” which is incorporated by reference herein in its entirety.

### FIELD OF THE INVENTION

The present invention generally relates to the field of compounds. In particular, the present invention is directed to consumables infused with compounds from cannabis, naturally-occurring substances, and mushrooms.

### BACKGROUND

Cannabis has been used to alleviate stress and other illnesses caused by posttraumatic stress disorder, seizures, epilepsy, multiple sclerosis, and the like. Mushrooms can be consumed for their taste and flavor as well as for compounds they contain. A wide variety of naturally-occurring substances are consumed as sources of vitamins, minerals, and other compounds that provide physical and mental health benefits along with promoting overall well-being. To date, there are no known consumables that contain cannabis compounds, compounds/vitamins and minerals from a wide variety of naturally-occurring substances, and mushroom compounds. Accordingly, there exists a need in the art for consumables that contain a combination of whole spectrum compounds from cannabis, whole spectrum compounds from a wide variety of naturally-occurring substances, and whole spectrum compounds from mushrooms.

### SUMMARY OF THE DISCLOSURE

In an aspect, a method of producing consumables infused with compounds from cannabis, naturally-occurring substances and mushrooms is disclosed. The method includes obtaining a food grade oil, obtaining cannabis, a mushroom compound and a naturally-occurring substance, infusing the food grade oil with the cannabis, the mushroom compound and the naturally-occurring substance, wherein infusing further includes infusing a first food grade oil of the food grade oil with the cannabis to yield a whole spectrum cannabis compounds infused food grade oil, infusing a second food grade oil of the food grade oil with the mushroom compound to yield a whole spectrum mushroom compounds infused food grade oil and infusing a third food grade oil of the food grade oil with the naturally-occurring substance to yield a whole spectrum naturally-occurring substance infused food graded oil, combining the whole spectrum cannabis compounds infused food grade oil with the whole spectrum naturally-occurring substance infused food grade oil and the whole spectrum mushroom compounds infused food grade oil to yield a combined food grade oil and infusing at least one orally ingestible consumable with the combined food grade oil.

In another aspect, a consumable infused with compounds from cannabis, naturally-occurring substances and mushrooms is disclosed. The consumable includes a combined food grade oil, wherein a food grade oil is infused with cannabis, a mushroom compound and a naturally-occurring substance, wherein infusing further includes infusing a first food grade oil of the food grade oil with the cannabis to yield a whole spectrum cannabis compounds infused food grade oil, infusing a second food grade oil of the food grade oil with the mushroom compound to yield a whole spectrum mushroom compounds infused food grade oil and infusing a third food grade oil of the food grade oil with the naturally-occurring substance to yield a whole spectrum naturally-occurring substance infused food graded oil and the whole spectrum cannabis compounds infused food grade oil, the whole spectrum naturally-occurring substance infused food grade oil and the whole spectrum mushroom compounds infused food grade oil are combined to yield the combined food grade oil and at least one orally ingestible consumable, wherein at least one orally ingestible consumable is infused with the combined food grade oil.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a flow diagram of an exemplary method of producing consumables infused with compounds from cannabis, naturally-occurring substances and mushrooms;

FIG. 2 illustrates a flow diagram of an exemplary two-step process of producing consumables infused with compounds from cannabis, naturally-occurring substances and mushrooms;

FIG. 3 illustrates a flow diagram of an exemplary method of infusing food grade oil with cannabis;

FIG. 4 illustrates a flow diagram of an exemplary method of infusing food grade oil with naturally-occurring substance;

FIG. 5 illustrates a flow diagram of an exemplary method of infusing food grade oil with mushroom;

FIG. 6 illustrates a flow diagram of an exemplary method of infusing whole spectrum cannabis compounds, whole spectrum naturally-occurring substance compounds, and whole spectrum mushroom compounds infused food grade oil with a consumable;

FIG. 7 illustrates a flow diagram of another exemplary method of producing consumables infused with compounds from cannabis, naturally-occurring substances and mushrooms;

FIG. 8 illustrates a flow diagram of another exemplary method of producing consumables infused with compounds from cannabis, naturally-occurring substances and mushrooms; and

FIG. 9 illustrates a block diagram of an exemplary consumable infused with compounds from cannabis, other naturally-occurring substances and mushrooms.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to consumables infused with compounds from cannabis, naturally-occurring substances, and mushrooms and a method of producing consumables infused with compounds from cannabis, naturally-occurring substances and mushrooms are disclosed. The method includes obtaining a food grade oil, obtaining cannabis, a mushroom compound and a naturally-occurring substance, infusing the food grade oil with the cannabis, the mushroom compound and the naturally-occurring substance, wherein infusing further includes infusing a first food grade oil of the food grade oil with the cannabis to yield a whole spectrum cannabis compounds infused food grade oil, infusing a second food grade oil of the food grade oil with the mushroom compound to yield a whole spectrum mushroom compounds infused food grade oil and infusing a third food grade oil of the food grade oil with the naturally-occurring substance to yield a whole spectrum naturally-occurring substance infused food graded oil, combining the whole spectrum cannabis compounds infused food grade oil with the whole spectrum naturally-occurring substance infused food grade oil and the whole spectrum mushroom compounds infused food grade oil to yield a combined food grade oil and infusing at least one orally ingestible consumable with the combined food grade oil. Exemplary embodiments illustrating aspects of the present disclosure are described below in the context of several specific examples.

Cannabis, also called as marijuana or hemp, is a genus of flowering plants that includes at least three species, Cannabis sativa, Cannabis indica, and Cannabis ruderalis.

Cannabis plants may produce a variety of potentially useful or beneficial compounds, such as cannabinoids, which produce mental and physical effects when consumed. Cannabinoids are a chemical group or family of 21-carbon-containing terpenophenolic compounds produced by Cannabis species. Current estimates of the number of cannabinoids found in Cannabis species is well in excess of 100 different cannabinoids. Cannabinoids may include Cannabidiol (CBD) and Tetrahydrocannabinol (THC). In addition to CBD and THC, other cannabinoids such as cannabichromene (CBC), cannabigerol (CBG), cannabinol (CBN), and others are present in varying amounts in cannabis plant material.

Consumed sources of cannabis compounds may include extracts, oils, isolates, and the like from Cannabis species including marijuana, hemp, and industrial hemp, which contains a THC content of less than 0.3% of overall mass. While providing useful or beneficial effects to the user, such extracts, oils, and isolates may have undesirable tastes, flavors, odors, and/or other unfavorable attributes. Accordingly, addition of hemp compound containing extracts or isolates to food or beverage consumables imparts an undesirable taste, since the extracts or isolates may have an undesirable taste.

A wide variety of mushrooms may be consumed directly or as flavoring for other foods. In addition, there may be mushrooms consumed for health effects and psychoactive effects. For example, lion's mane mushrooms are valued for their health benefits. A class of mushrooms, also called psilocybin mushrooms and also referred to as magic mushrooms, may be consumed for their psychoactive and psychedelic effects. These mushrooms contain psilocybin, a naturally occurring psychedelic compound that is converted in the liver into psilocin, which produces a psychoactive effect. The composition of psilocybin mushrooms varies from one species to another, with varying amounts of psilocybin as well as other compounds including psilocin, norpsilocin, baeocystin, norbaeocystin, and aeruginascin. These other compounds may modify the effects of psilocybin mushrooms in a manner that makes the combination of compounds preferable to consumption of just psilocybin.

There may be methods of consuming psilocybin mushrooms to obtain a desired psychoactive effect (s). Psilocybin mushrooms may be eaten, either as fresh or dried mushrooms, which has the significant drawbacks of a poor, bitter taste, requirement of significant chewing of the mushrooms, and often, queasiness from consumption. Another form of consumption may be to make and drink a mushroom tea, which again can have an unpleasant taste. Yet another form of consumption may be to grind mushrooms and add mushroom powder to a variety of foods, which can be messy, coupled with an unpleasant taste. Other forms of consumption include mushroom chocolate and a technique called lemon tek, where psilocybin mushrooms are soaked in lemon juice or some other kind of acidic liquid.

A wide variety of naturally-occurring substances may be consumed as sources of vitamins, minerals, and other compounds that provide physical and mental health benefits along with promoting overall well-being. Such substances may include sea mosses, barks, roots, mosses, herbs, hops, teas, and so forth. These substances can be consumed directly for their benefits, used in various beverages for consumption, and used as additives to various foods and beverages for consumption. While consumption of such naturally-occurring substances can provide numerous benefits, the consumption may have drawbacks, such as unpleasant taste, difficult to work with forms that require grinding into messy powders or preparation of inconvenient extracts, and so forth.

Plants in the cannabis family (e.g., hemp, marijuana, etc.) produce a number of beneficial compounds, including cannabinoids. To date, more than 100 cannabinoids have been identified, accounting for up to 40% of the plant's extract. Cannabinoids may include Cannabidiol (CBD), Cannabigerol (CBG), Tetrahydrocannabinol (THC) among others, each of which may include a variety of health benefits.

Mushrooms may be consumed for their flavors, health benefits, and psychoactive effects. The flavors, health benefits, and psychoactive effects of mushrooms can be attributed to one or more compounds found in mushrooms.

A wide variety of other naturally-occurring substances are consumed as sources of vitamins, minerals, and other compounds that provide physical and mental health benefits along with promoting overall well-being. Such substances include, but are not limited to, sea mosses, barks, roots, mosses, herbs, hops, teas, and so forth.

The presently disclosed combination of cannabis compounds, compounds from other naturally-occurring substances, and mushroom compounds infused into consumables and methods of producing such consumables provide for a wide range of food and beverage consumables that impart desired qualities and effects as a result of combined, infused compounds from cannabis, other naturally-occurring substances, and mushrooms in the consumables.

The cannabis, other naturally-occurring substances, and mushroom compounds infusion methods described herein can be used to infuse a wide variety of food consumables, which in some instances can in turn be used to make an infused beverage. Virtually any food consumable that can be effectively manipulated in the method(s) described herein can be a candidate for infusion with cannabis, other naturally-occurring substances, and mushroom compounds. Examples of such foods include, but are not limited to, coffee beans, cacao beans, raw nuts and seeds, roasted nuts and seeds, popcorn kernels, dehydrated fruit, raw fruit, raw vegetables, trail mix, granola bars, garlic, beans, bacon, ice cream, jams and jellies, baked goods, caramel sauce, and freeze-dried consumables.

As used herein, the terms “infused cannabis compounds, other naturally-occurring substances compounds, and mushroom compounds” or “cannabis, other naturally-occurring substances, and mushroom compounds infused” refers to consumables to which whole spectrum compounds from cannabis, other naturally-occurring substances, and mushrooms have been infused by a method(s) disclosed herein. The infusion method generally involves preparing a food grade oil (such as coconut oil or a similar food grade oil) that is infused with whole spectrum cannabis compounds, whole spectrum compounds from other naturally-occurring substances, and whole spectrum mushroom compounds. The food grade oil infused with whole spectrum cannabis compounds, compounds from other naturally-occurring substances, and mushroom compounds is then used to infuse consumables as detailed herein. Throughout this specification, cannabis, other naturally-occurring substances compounds, and mushroom compounds infused food and/or drink may be referred to as “cannabis, other naturally-occurring substances, and mushroom compounds infused” or simply “infused,” such as “cannabis, other naturally-occurring substances, and mushroom compounds infused cacao beans” or “infused cacao beans.”

As used herein, the terms “other naturally-occurring substances” refers to a wide variety of naturally-occurring substances other than cannabis and mushrooms that are consumed for a variety of physical health, mental health, and general well-being benefits. Such other naturally-occurring substances include, but are not limited to, sea mosses, barks (such as elderberry bark), roots (such as burdock root), mosses, black seed, herbs, hops, teas, and so forth. As such, “other naturally-occurring substances” or “other naturally-occurring substance(s)” refers to such substances individually as well as collectively.

The beneficial effects obtained from other naturally-occurring substances derive from vitamins, minerals, and other compounds contained in the other naturally-occurring substances. The infusion methods detailed herein provide for the transfer of whole spectrum compounds from other naturally-occurring substances into a food grade oil, and in turn the transfer of those whole spectrum compounds from the infused food grade oil into another consumable. Accordingly, the methods detailed herein include the infusion of vitamins, minerals, and other beneficial compounds from other naturally-occurring substances into various orally ingestible consumables. For the purposes of this disclosure, an “orally ingestible consumable” is any substance that is consumed by living organisms through an oral pathway to provide energy, nutrients, and other essential substances needed for growth and maintenance of the body. As a non-limiting example, orally ingestible consumable may include coffee beans, cacao beans, popcorns, fruits, dehydrated fruits, vegetables, nuts, seeds, granola bars, energy bars, bacon, garlic, beans, ice cream, jams, jellies, caramel sauce, baked goods, or any consumables described in this disclosure.

As described herein, in an embodiment, consumables are infused with whole spectrum compounds from a combination of whole spectrum cannabis compounds, whole spectrum compounds from other naturally-occurring substances, and whole spectrum mushroom compounds. In an alternative embodiment, consumables are infused with whole spectrum compounds from a combination of whole spectrum cannabis compounds and whole spectrum compounds from other naturally-occurring substances. In another embodiment, consumables are infused with whole spectrum compounds from a combination of whole spectrum mushroom compounds and whole spectrum compounds from other naturally-occurring substances.

A food grade oil infused with whole spectrum cannabis compounds, compounds from other naturally-occurring substances, and mushroom compounds may be prepared using any of a number of approaches. In an embodiment, separate cannabis compounds, naturally-occurring substances compounds, and mushroom compounds infused food grade oils are initially prepared independently and then combined to yield a food grade oil infused with whole spectrum cannabis compounds, naturally-occurring substances compounds, and whole spectrum mushroom compounds.

In another embodiment, separate cannabis compounds, naturally-occurring substances compounds, and mushroom compounds infused food grade oils are initially prepared independently and then combined in a stepwise fashion. In this manner, an embodiment includes infusing a food grade oil infused with compounds from other naturally-occurring substances and then first combining that infused food grade oil with a food grade oil infused with mushroom compounds to yield a food grade oil infused with compounds from other naturally-occurring substances and mushrooms. This infused oil is in turn combined with a food grade oil infused with cannabis compounds to yield a food grade oil infused with whole spectrum compounds from other naturally-occurring substances, cannabis, and mushrooms.

In alternative embodiments, a food grade oil infused with whole spectrum compounds from cannabis, other naturally-occurring substances, and mushrooms is prepared in a stepwise manner in three overall steps as follows. Initially, a food grade oil may be infused with whole spectrum compounds from a first starting material, such as cannabis. Next, that food grade oil infused with a first starting material (such as cannabis) may be infused with a second starting material, such as another naturally-occurring substance (a bark, a root, sea moss, combinations thereof, etc.). Finally, that double infused food grade oil may be infused with a third starting material from mushrooms, to yield a triple infused food grade oil (infused with compounds from cannabis, another naturally-occurring substance(s), and mushrooms). A triple infused food grade oil can be prepared in this manner using any desired order of starting material (cannabis, other naturally-occurring substance(s), and mushrooms) in the overall three steps.

In further embodiments, a food grade oil infused with whole spectrum compounds from cannabis, other naturally-occurring substances, and mushrooms may be prepared by combining two or more starting materials (selected from cannabis, other naturally-occurring substances, and mushrooms) and infusing food grade oil with the combined starting materials. In one scenario, all three types of starting material (cannabis, other naturally-occurring substance(s), and mushrooms) are combined and infused into a food grade oil. In another scenario, two types of starting material are combined and infused into a food grade oil (for example, other naturally-occurring substance(s) and mushrooms), and then that double infused food grade oil may be combined with a single infused food grade oil (such as a cannabis infused oil) to yield a triple infused food grade oil. Alternatively, a double infused oil prepared from a combination of two starting materials (such as other naturally-occurring substances and mushrooms) can be used as a starting oil which may be in turn infused with a third starting material (such as cannabis) to yield a triple infused food grade oil.

As used herein, the terms “single infused,” “double infused,” and “triple infused” refers to infusion of a food grade oil with a single, double, or triple class of starting material. For example, a cannabis infused food grade oil can be produced with a combination of two or more species of cannabis and be referred to as a cannabis compounds “single infused” food grade oil. Likewise, a food grade oil infused with other naturally-occurring substances can be infused with two or more substances, such as sea moss and elderberry root, and be referred to as a food grade oil that is “single infused” with compounds from other naturally-occurring substances. Similarly, a food grade oil infused with mushrooms can be infused with two or more types of mushrooms, such as lion's mane and psilocybin, and be referred to as food grade oil that is “single infused” with mushroom compounds.

Accordingly, “double infused” refers to a food grade oil that is infused with two classes of compounds, wherein each class can be produced with one, two, or more starting materials. For example, a food grade oil that is “double infused” with compounds from cannabis (as a first class) and other naturally-occurring substances (as a second class) can be produced using one, two, or more species of cannabis as starting material along with one, two, or more types/species of other naturally-occurring substances, such as a combination of sea moss, a bark, and a root. Likewise, “triple infused” refers to food grade oil that is infused with three classes of compounds, wherein each class can be produced with one, two, or more starting materials. In this instance, a food grade oil that is “triple infused” with compounds cannabis, other naturally-occurring substances, and mushrooms can be produced using one, two, or more species of cannabis as starting material; one, two, or more types/species of other naturally-occurring substances, such as a combination of sea moss, a bark, and a root; and one, two, or more types/species of mushroom, such as lion's mane and psilocybin.

The infusion methods detailed herein generally involve preparing a mixture made with stating material (such as cannabis plant materials, other naturally-occurring substance(s) materials, and/or mushroom materials) and a food grade oil (such as coconut oil or a similar food grade oil) under specific heating and cooling/freezing conditions to produce a whole spectrum compounds (compounds from cannabis, other naturally-occurring substance(s), mushroom, or combination thereof) infused oil. After a food grade oil infused with compounds from cannabis, other naturally-occurring substance(s), and mushrooms is produced, the infused oil may be then used to infuse consumables under specific heating and cooling/freezing conditions to produce whole spectrum compounds infused consumables, as detailed herein.

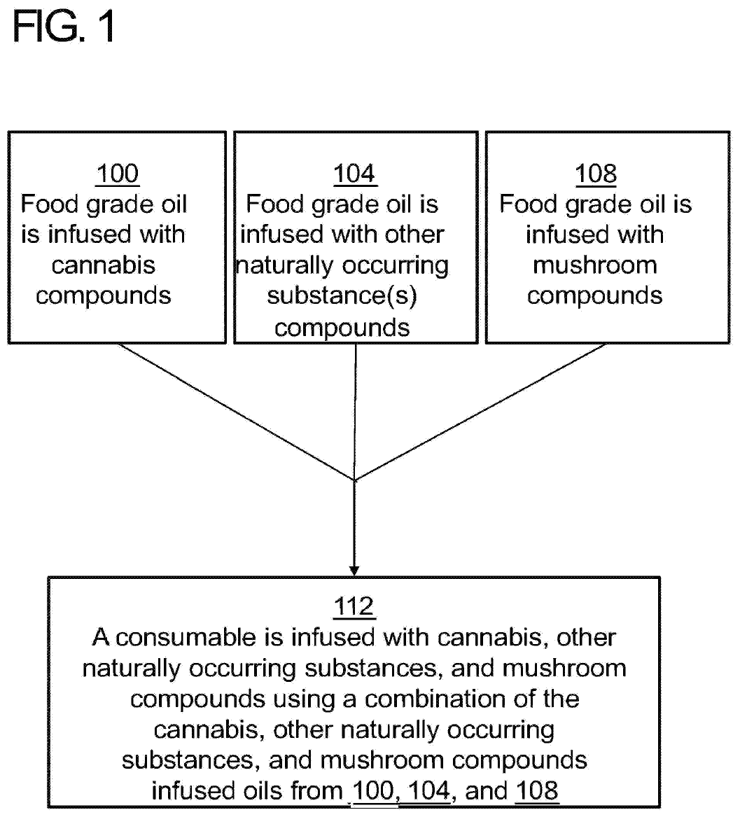

In some embodiments as shown in FIG. 1, cannabis compounds, other naturally-occurring substance(s) and mushroom compounds infused foods and/or drinks prepared by the methodology disclosed herein may be generated in an overall four-step process. In this process, independent food grade oils infused with cannabis whole spectrum compounds, other naturally-occurring substance(s) whole spectrum compounds, and mushroom whole spectrum compounds infused food grade oils may be produced separately and then combined to yield an oil infused with whole spectrum cannabis compounds, whole spectrum other naturally-occurring substance(s) compounds, and whole spectrum mushroom compounds. In the first step (at 100), whole cannabis plant material, for instance, but not limited to, small buds, may be used to infuse a food grade oil, such as coconut oil, with cannabis compounds. Alternatively, whole cannabis plant material that has been ground can be used to infuse an oil. Note that because whole cannabis plant material can be used at 100, the resulting infusion of the oil from the cannabis may provide a full spectrum of compounds from the cannabis infused into the oil. The infused oil can also be regarded as a cannabis extract.

With continued reference to FIG. 1, in a second step (at 104), a naturally-occurring substance(s) may be used to infuse a food grade oil such as coconut oil, with compounds from the naturally-occurring substance(s). Note that because whole naturally-occurring substance(s) material is used at 104, the resulting infusion of the oil from the naturally-occurring substance(s) material may provide a full spectrum of naturally-occurring substance(s) compounds from the naturally-occurring substance(s) material infused into the oil. The infused oil can be regarded as a naturally-occurring substance(s) extract.

With continued reference to FIG. 1, in a third step (at 108), mushroom material (whole mushrooms or parts of mushrooms) may be used to infuse a food grade oil, such as coconut oil, with mushroom compounds. Note that because whole mushroom material (whether whole or parts of mushrooms) may be used at 108, the resulting infusion of the oil from the mushroom material provides a full spectrum of mushroom compounds from the mushroom material infused into the oil. The infused oil can be regarded as a mushroom extract.

With continued reference to FIG. 1, in a fourth step (at 112), cannabis compounds infused food grade oil may be combined with a naturally-occurring substance(s) infused food grade oil and mushroom compounds infused food grade oil. The combination infused food grade oil may be used to infuse an end food product/consumable with whole spectrum cannabis compounds, other naturally-occurring substance(s) compounds, and mushroom compounds. After the end product is infused with whole spectrum compounds from cannabis, other naturally-occurring substance(s), and mushrooms, it may be consumed in any typical fashion, such as direct consumption, used to make a beverage as in the case of coffee or cacao beans, and so forth.

With continued reference to FIG. 1, in an alternative embodiment, cannabis compounds, other naturally-occurring substances, and mushroom compounds infused foods and/or drinks prepared by the methodology disclosed herein are generated in another overall four-step process. In the first step, a food grade oil may be infused with a single, first starting class of material. This first starting material compounds infused food grade oil may be next infused with a second starting class of starting material to yield a food grade oil double infused with compounds from the first and second classes of starting materials. In a third step the double infused food grade oil may be next infused with a third class of starting material to yield a food grade oil triple infused with compounds from the first, second, and third classes of starting materials. The classes of starting materials used in this embodiment may include cannabis, other naturally-occurring substance(s), and mushrooms. The food grade oil can be infused stepwise in any desired order of first, second, and third starting materials. For example, a food grade oil can be stepwise infused with cannabis, followed by a naturally-occurring substance(s), and then finally by mushrooms. In a fourth step, the triple infused food grade oil may be used to infuse an end food product/consumable with whole spectrum cannabis compounds, other naturally-occurring substance(s) compounds, and mushroom compounds.

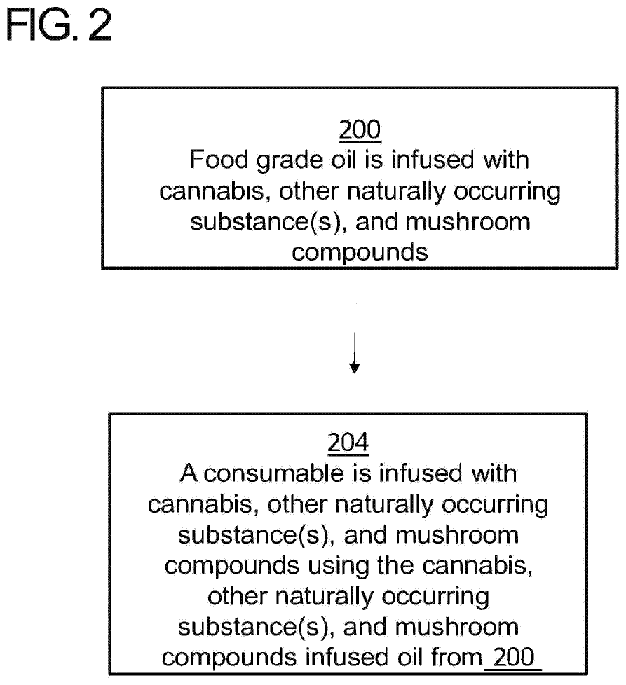

Referring now to FIG. 2, in yet another alternative embodiment, cannabis compounds, other naturally-occurring substance(s) compounds, and mushroom compounds infused foods and/or drinks prepared by the methodology disclosed herein may be generated in an overall two-step process as shown in FIG. 2. In the first step (at 200), whole cannabis plant material, for instance, but not limited to, small buds, may be combined with a naturally-occurring substance(s) material and mushroom material (whole mushrooms or parts of mushrooms). The combined starting materials may be used to infuse a food grade oil, for instance, but not limited to, coconut oil, with cannabis, other naturally-occurring substances, and mushroom compounds. Alternatively, whole cannabis plant material that has been ground can be used in place of buds. Note that because whole cannabis, other naturally-occurring substance(s), and mushroom materials are used, the resulting infusion of the food grade oil from the cannabis, other naturally-occurring substance(s), and mushroom materials provides a full spectrum of compounds from the cannabis, other naturally-occurring substance(s), and mushroom materials infused into the oil. The infused oil can be regarded as a cannabis, other naturally-occurring substance(s), and mushroom extract. In a second step (at 204), cannabis, other naturally-occurring substance(s), and mushroom compounds infused food grade oil may be used to infuse an end food product/consumable with whole spectrum cannabis compounds, whole spectrum other naturally-occurring substance(s) compounds, and whole spectrum mushroom compounds. After the end product is infused with whole spectrum cannabis compounds, other naturally-occurring substance(s) compounds, and mushroom compounds, it may be consumed in any typical fashion, such as direct consumption, used to make a beverage as in the case of coffee or cacao beans, and so forth.

With continued reference to FIG. 2, consumption of the cannabis, other naturally-occurring substances, and mushroom compounds infused food and drink consumables generated by the methods described herein provides the beneficial effects generally associated with cannabis, other naturally-occurring substances, and mushrooms. These cannabis effects include, but are not limited to, mental and physical effects, such as pain relief from CBDs and other cannabinoids, mental high from THC (in foods infused with marijuana cannabinoids), and other effects attributed to consumption of cannabinoids. Likewise, these benefits from other naturally-occurring substances include a wide variety of beneficial effects, for example but not limited to immunity boosting from sea moss; anti-inflammatory effects from black seed and burdock root; diuretic effects of elderberry bark; and so forth. Furthermore, beneficial mushroom effects include, but are not limited to, food flavoring, mental and physical effects, psychoactive effects (such as in foods infused with psilocybin containing mushrooms), and other effects attributed to consumption of mushrooms.

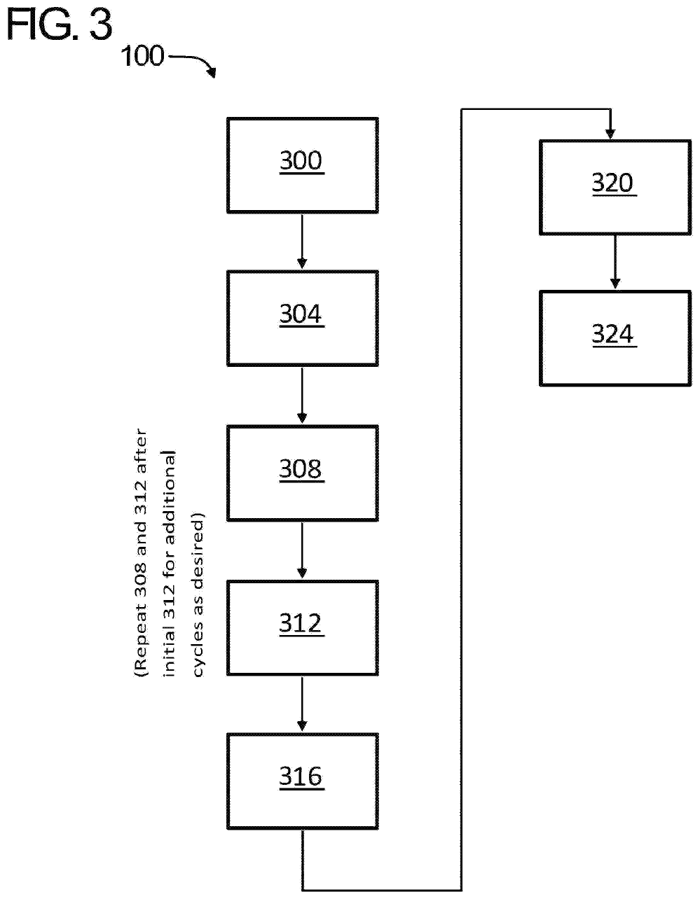

Referring now to FIG. 3, FIG. 3 refers to steps that may be taken to infuse a food grade oil with cannabis compounds to complete step 100 of FIG. 1. Suitable food grade oils for this process may include, but are not limited to, coconut oil, medium chain triglycerides (MCT) oil, vegetable oil, sunflower oil, grape seed oil, olive oil, avocado oil, and combinations thereof. Likewise, butter, shortening, margarine, or lard may be used in the process.

In one embodiment as shown in FIG. 3, whole, raw cannabis plant material (e.g., flowers, buds, leaves, or other plant material; for instance, but not limited to, small buds) may be frozen (at 300). The cannabis plant material can be used whole or ground (which is, for instance, but not limited to, produced by grinding the frozen plant material). The cannabis plant may include Cannabis Sativa, Cannabis Indica, Cannabis Ruderalis, other types of cannabis and any combination thereof. The cannabis may be classified as marijuana, hemp, and/or other types of cannabis.

With continued reference to FIG. 3, cannabis plant material may also be a strain that is particularly rich in one or more specific cannabinoids, such as a strain that is particularly rich in cannabidiol (CBD) or cannabigerol (CBG). In addition, the cannabis plant material may be a combination of two or more different strains that are particularly rich for a specific cannabinoid. Currently available cannabis strains may be rich in CBD, but strains that are rich for other cannabinoids have been and are being developed. For example, more recently developed strains include those that are rich in CBG. Generally, cannabigerol (CBG) and cannabigerolic acid (CBGA) only account for 1% of a hemp strain's total cannabinoids. In a CBG-rich hemp strain, cannabigerol makes up around 10-15% or more of the cannabis flower's total cannabinoids. In an embodiment, the cannabis plant material used in the presently disclosed method(s) may be a mixture of equal parts of two strains that are rich in CBD and CBG, respectively. Additional strains that are particularly rich in a specific cannabinoid and combinations thereof fall within the scope of the presently disclosed method(s).

With continued reference to FIG. 3, next (at 304), a suitable food grade oil such as coconut oil, MCT oil, a combination of coconut oil and MCT oil (or similar oil as described above) may be heated to a temperature equal to or between 170° and 240° F., and to about 185° F. For the purposes of this specification, the term “about” used in relation to temperatures will mean within ±1%. Regarding a combination of coconut oil and MCT oil, an embodiment may be to use a ratio of 75% coconut oil to 25% MCT oil. Alternatively, ratios of coconut oil to MCT oil can range from essentially any ratio of the two oils, such as, but not limited to, 90% coconut oil: 10% MCT to 10% coconut oil: 90% MCT oil.

With continued reference to FIG. 3, next (at 308), the frozen cannabis (in an embodiment, small buds) may be added to the food grade oil and held at the temperature between 170° and 240° F. (e.g., in an embodiment, at about 185° F.) for 4-12 hours (in an embodiment, 6-9 hours), while occasionally (or continuously) stirring the mixture. In some embodiments, the ratio of plant material to coconut oil may be 1 lb. plant material to 2 gallons oil. For example, on a commercial scale, 100 lbs. plant material/buds may be mixed with 200 gallons of oil. However, other ratios within 10%, 20%, 30%, 40%, 50%, 75%, 100% of this ratio also may be used. In general, the ratio may be chosen to provide high levels/concentration(s) of cannabis compounds within the oil.

With continued reference to FIG. 3, after the heating step of 308, in the next step (at 312), the cannabis and food grade oil mixture may be frozen to obtain a solid, frozen biomass of cannabis and food grade oil mixture. For the purposes of this disclosure, a “biomass” is a body of matter. In some embodiments, biomass may be solid or liquid. In some embodiments, biomass may be frozen or liquid. As a non-limiting example, biomass may include a body of cannabis and food grade oil mixture, a body of mushroom compound and food grade oil mixture, a body of naturally occurring substance and food grade oil mixture, or the like.

With continued reference to FIG. 3, at this juncture, the solid, frozen biomass of cannabis and food grade oil can be processed in one of several ways. First, the cannabis and food grade oil can be heated and strained as per steps 316, 320, and 324 to yield cannabis compounds infused food grade oil produced by a single round or phase of heating and freezing. Second, the cannabis and food grade oil alternatively can be treated with a second round or phase of heating and freezing, in which steps 308 and 312 are repeated, followed by subsequent steps 316, 320, and 324 to yield cannabis compounds infused food grade oil produced by two rounds of heating and freezing. Third, the cannabis and food grade oil alternatively can be treated with a third round or phase of heating and freezing, in which steps 308 and 108 are repeated twice, followed by subsequent steps 316, 320, and 324 to yield cannabis compounds infused food grade oil produced by three rounds of heating and freezing The single round/phase treatment will produce cannabis compounds infused food grade oil having a lesser relative level of infused cannabis compounds compared to a double round/phase treatment. While the double round/phase treatment has been found to provide preferable levels of cannabis compounds infused into the food grade oil, in some instances, a third round/phase treatment may be more preferable. The single round/phase treatment can produce cannabis compounds-infused food grade oil that is adequate for many applications. If higher infused levels of cannabis compounds in food grade oil are desired for a particular application, the double round/phase treatment or even triple round/phase treatment of cannabis compounds infused food grade oil can be applied.

With continued reference to FIG. 3, following step 312, at step 316, the solid, frozen cannabis and food grade oil biomass may be reheated to 150° to 200° F., and to about 185° F., and held at the temperature for a sufficient period of time to liquify the mixture, for instance, but not limited to, for about 2-4 hours.

With continued reference to FIG. 3, next (at 320), the cannabis and food grade oil mixture may be strained using a press bag (or other suitable straining techniques) to separate the cannabis compounds infused food grade oil from the cannabis biomass. Note that the cannabis compounds infused food grade oil can also be referred to as a cannabis extract.

With continued reference to FIG. 3, in a further step (324), the strained, cannabis compounds infused food grade oil may be heated to between 250° F. to 350° F. for 3-6 hours. This step will decarboxylate the carboxylated cannabinoids in the oil, such as CBD-A or THC-A The temperature and time will vary based in part on the cannabis strain used and desired decarboxylation. For example, using a CBD-rich strain that provides high levels of CBD-A, the step may include a temperature of 250° F. for 3-6 hours. In another example, using a CBG-rich strain that provides high levels of CBG-A, the step may include a temperature of 300° F. for 3-6 hours.

With continued reference to FIG. 3, this method results in a cannabis whole spectrum compounds infused food grade oil that may be used in combination with food grade oils infused with whole spectrum compounds from a naturally-occurring substance(s) and whole spectrum compounds from mushrooms compounds for infusing consumables with whole spectrum cannabis compounds, whole spectrum compounds from a naturally-occurring substance(s), and whole spectrum mushroom compounds as described below.

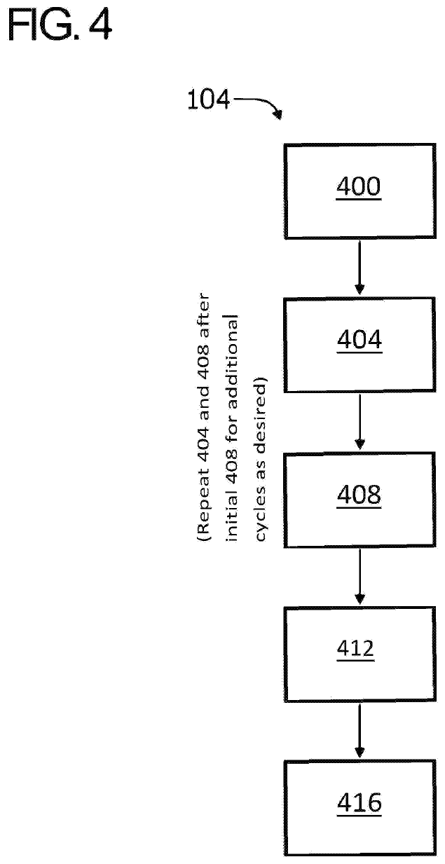

Referring now to FIG. 4, FIG. 4 refers to steps that may be taken to infuse a food grade oil with compounds from other naturally-occurring substances to complete step 104 of FIG. 1. Suitable food grade oils for this process may include, but are not limited to, coconut oil, medium chain triglycerides (MCT) oil, vegetable oil, sunflower oil, grape seed oil, olive oil, avocado oil, and combinations thereof. Likewise, shortening, margarine, butter, or lard may be used in the process.

With continued reference to FIG. 4, for the methods described herein, “other naturally-occurring substances” refers to a wide variety of naturally-occurring substances other than cannabis and mushrooms that are consumed for a variety of physical health, mental health, and general well-being benefits. Such naturally-occurring substances include, but are not limited to, sea mosses, barks, roots, mosses, black seed, herbs, spices, hops, teas, and so forth. In some embodiments, other naturally-occurring substance may include an anti-inflammatory compound or an anti-bacterial compound.

With continued reference to FIG. 4, sea moss, also called as Irish moss or red seaweed, may be consumed for many health benefits such as immunity boosting, liver detoxification, increasing blood hemoglobin, as well as a source of vitamins and minerals such as vitamin B2, vitamin B12, calcium, chromium, magnesium, and zinc. Consumed sea moss varieties may include purple sea moss, yellow/gold sea moss, and green sea moss. Virtually any type of sea moss can be applicable for the infusion methods described herein.

With continued reference to FIG. 4, several types of barks may be consumed or extracted for health benefits, such as inflammation reduction, heart health, wound healing, improved cognition, and so forth. Barks can be a source of many health-promoting plant compounds, including but not limited to, vitamins, polyphenols, and other phytonutrients. Such barks include, but are not limited to, elderberry bark, pine bark, magnolia bark, willow bark, and cinnamon bark. Accordingly, any type of bark that may provide compounds that promote health and well-being can be used in the infusion methods described herein.

With continued reference to FIG. 4, many types of roots may be likewise consumed or extracted for health and well-being benefits, such as anti-inflammatory and anti-bacterial benefits, promoting good blood circulation, skin health, liver support, and so forth. Roots can be source of many healthy compounds including vitamins, minerals, and nutrients such as antioxidants, flavonoids, phytochemicals, inulin, and so forth. Roots that may include beneficial effects include, but are not limited to, burdock root, lotus root, chicory root, taro root, celery root, and so on. Any type of root that may provide compounds that promote health and well-being can be used in the infusion methods described herein.

With continued reference to FIG. 4, mosses are another type of naturally-occurring substances that may have beneficial applications that accordingly make them well suited for the infusion methods described herein. For example, liverwort moss has gained attention for medicinal benefits of treating nausea, inflammation, and muscle cramps.

With continued reference to FIG. 4, yet another naturally-occurring substance with application in the infusion methods described herein may include black seed, which has been suggested to have health benefits that aid with inflammation, asthma, high cholesterol, autoimmune disorders, and diabetes.

With continued reference to FIG. 4, herbs and spices have long been recognized as naturally-occurring substances that can provide health benefits and as such may be used in the infusion methods described herein. Potential herb and spice benefits include anti-inflammatory and anticarcinogenic activities; glucose and cholesterol-lowering activities, and properties that affect cognition and mood. Herbs and spices contain a wide range of compounds with beneficial effects, such as flavonoids and polyphenols. Accordingly, herbs and spices such as but not limited to, ginger, turmeric, rosemary, garlic, cumin, cardamom, cinnamon, and so forth may be used in the presently described infusion methods. Virtually any herb or spice that may provide beneficial effects and/or flavoring may be a candidate for use in the infusion methods described herein.

With continued reference to FIG. 4, hops may be another naturally-occurring substance that may be used in the infusion methods described herein. The flowering part of the hops plant may be beneficial for addressing a myriad of issues, such as but not limited to, anxiety, insomnia, irritability, high cholesterol, nerve pain, skin leg ulcers; intestinal cramps, and may serve as an antibacterial agent. Accordingly, the flowering part of the hops plant may be used in the infusion methods described herein.

With continued reference to FIG. 4, different types of teas have long been recognized for potential health and well-being benefits, such as but not limited to, lowering cholesterol, weight loss; addressing cancer, heart disease, and diabetes; and promoting mental awareness. Teas contain a wide variety of potentially beneficial compounds, such as but not limited to, polyphenols, flavonoids, caffeine, and theanine. Accordingly, a wide variety of teas, such as but not limited to, green tea, black tea, white tea, oolong tea, and pu-erh tea, and so on may be used in the infusion methods described herein.

With continued reference to FIG. 4, as shown in FIG. 4 (at 400), a suitable food grade oil such as coconut oil, MCT oil, another similar oil as described above, a combination of coconut oil and MCT oil, or a combination of two or more similar oils as described above, may be heated to a temperature equal to or between about 170° and 240° F. For the purposes of this specification, the term “about” used in relation to temperatures will mean within ±1%. Regarding a combination of coconut oil and MCT oil, an embodiment may be to use a ratio of 75% coconut oil to 25% MCT oil. Alternatively, ratios of coconut oil to MCT oil can range from any ratio of coconut oil to MCT oil, such as, but not limited to, 90% coconut oil: 10% MCT oil to 10% coconut oil: 90% MCT oil.

With continued reference to FIG. 4, next (at 404), the naturally-occurring substance or a combination of naturally-occurring substances may be added to the food grade oil and held at the temperature between 170° and 240° F. for 4-12 hours (for instance, but not limited to, 6-9 hours or 8 hours), while occasionally (or continuously) stirring the mixture. In some embodiments, the ratio of naturally-occurring substance material to food grade oil may be 1 lb. material to 1 gallon of oil (in this instance, this can be referred to as a 1:1 ratio), other ratios within 10%, 20%, 30%, 40%, 50%, 75%, 100% of the ratio also may be used. In a non-limiting example, the ratio of naturally-occurring substance material to food grade oil may be 1 lb. material to 0.1 gallon of oil. In another non-limiting example, the ratio of naturally-occurring substance material to food grade oil may be 1 lb. material to 0.5 gallon of oil. In general, the ratio will be chosen to provide high levels/concentration(s) of naturally-occurring substance compounds within the oil.

With continued reference to FIG. 4, in an exemplary embodiment, a combination of sea moss, elderberry bark, burdock root, and black seed may be used to infuse food grade oil. In this example, 1 lb. dried sea moss, 1 lb. dried elderberry bard, 1 lb. burdock root, and 1 lb. black seed may be added to 1 gallon of food grade oil, such as coconut oil.

With continued reference to FIG. 4, after the heating step of 404, in the next step (at 408), the naturally-occurring substance and food grade oil mixture may be frozen to obtain a solid, frozen biomass of naturally-occurring substance material and food grade oil mixture.

With continued reference to FIG. 4, at this juncture, the solid, frozen biomass of naturally-occurring substance material and food grade oil can be processed in one of several ways. First, the frozen biomass can be heated and strained as per steps 412 and 416 (below) to yield a naturally-occurring substance compounds infused food grade oil produced by a single cycle or phase of heating and freezing. Second, the frozen biomass alternatively can be treated with a second cycle or phase of heating and freezing, in which steps 404 and 408 are repeated, followed by subsequent steps 412 and 416 to yield naturally-occurring substance compounds infused food grade oil produced by two cycles of heating and freezing. Third, the second cycle treatment can be followed by a third cycle or phase of heating and freezing, in which steps 404 and 408 are repeated twice, followed by subsequent steps 412 and 416 to yield naturally-occurring substance compounds infused food grade oil produced by three cycles of heating and freezing. Fourth, following a third cycle, the frozen biomass can be treated by a fourth cycle or phase of heating and freezing, in which steps 404 and 408 are repeated three times, followed by heating the frozen biomass and straining it as per steps 412 and 416 to yield naturally-occurring substance compounds infused food grade oil produced by four cycles or phases of heating and freezing.

With continued reference to FIG. 4, single cycle/phase treatment may produce naturally-occurring substance compounds infused food grade oil having a lesser relative level of infused naturally-occurring substance compounds compared to a double cycle/phase treatment that may yield a greater level of infused compounds. For some particular applications, a third and/or fourth cycle treatment may yield an even greater level of infused naturally-occurring substance compounds than a single or double cycle treatment. In an embodiment, a three-cycle treatment may be used.

With continued reference to FIG. 4, following step 408, at step 412, the solid, frozen naturally-occurring substance and food grade oil biomass may be reheated to 150° to 200° F. and held at the temperature for a sufficient period of time to liquify the mixture, for instance, but not limited to, for about 2-4 hours.

With continued reference to FIG. 4, next (at 416), naturally-occurring substance and food grade oil mixture may be strained using a press bag (or other suitable straining techniques) to separate the naturally-occurring substance compounds infused food grade oil from the naturally-occurring substance biomass.

With continued reference to FIG. 4, this method results in a food grade oil infused with whole spectrum naturally-occurring substance compounds that may be used in combination with a whole spectrum cannabis compounds infused food grade oil and/or a whole spectrum mushroom compounds infused food grade oil for infusing consumables, as described below. The infused food grade oil may be referred to as a naturally-occurring substance(s) extract.

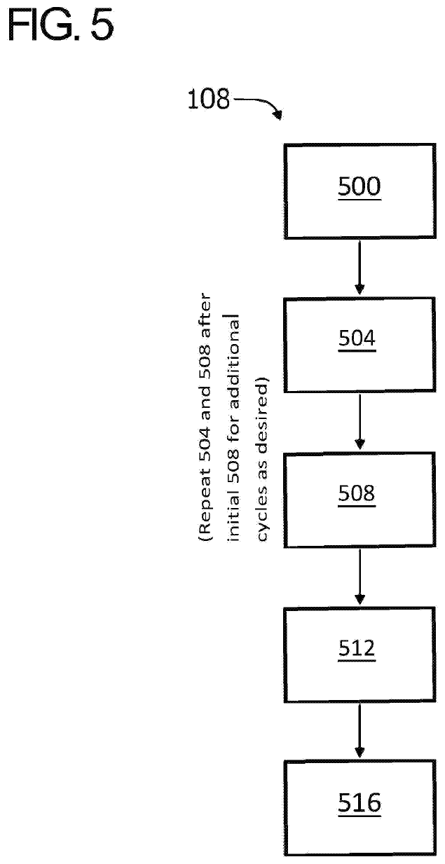

Referring now to FIG. 5, FIG. 5 refers to steps that may be taken to infuse a food grade oil with mushroom compounds to complete step 108 of FIG. 1. Suitable food grade oils for this process include, but are not limited to, coconut oil, medium chain triglycerides (MCT) oil, vegetable oil, sunflower oil, grape seed oil, olive oil, avocado oil, and combinations thereof. Likewise, shortening, margarine, butter, or lard may be used in the process.

In one embodiment as shown in FIG. 5, whole or parts of mushrooms can be used in the process, depending on the desired infusion effects. Parts of mushrooms may have a higher concentration of a desired, specific compound or compounds, such that the most effective infusion occurs with a part of a mushroom (rather than whole mushrooms). Accordingly, it may be preferable to use just mushroom caps, stalks/stems, mycelium, combinations thereof, and so forth in the presently described method(s). For example, a particular species of psilocybin mushroom might contain higher concentrations of psilocybin in the cap as opposed to the stem, such that it's advantageous to conduct the infusion with just caps, rather than the whole mushroom.

With continued reference to FIG. 5, virtually any type, variety, or species of mushroom can be used in the presently described method(s). For example, infusion of mushroom flavors can be obtained from any particular mushroom variety consumed for its flavor or in cooking, such as, but not limited to Chanterelle, Truffle-Black & White, Morel, Trumpet-King & Black, Oyster, Shiitake, Maitake-Hen of the Woods, Cremini, Lobster, Porcini, Hedgehog, Portobello, Button/White, Enoki, Beech, and combinations thereof. Infusion of compounds that may help reduce the effects of stress on one's body can be obtained from adaptogenic mushrooms, such as Cordyceps, Lion's Mane, and Reishi mushrooms. Likewise, exemplary species of mushrooms recognized for exemplary beneficial effects and function can include, but are not limited to, Argarikon (immune response), Cordyceps (energy, stamina, and libido), Chaga (antioxidants, immunity balancer, anti-inflammatory, and energy), Lion's Mane (cognitive function, concentration, focus, and sleep), Maitake (immunity booster and anti-inflammatory), Reishi (immunity booster, stress and anxiety relief, and sleep), Turkey Tail (immune function and gut), Shiitake (immunity booster, hair, skin and nails), and combinations thereof. In addition, there are well over 100 species of psilocybin mushrooms that contain psilocybin, which is a psychoactive and psychedelic compound that may have beneficial effects with respect to treating addiction, depression, death anxiety, anorexia, demoralization syndrome, and obsessive-compulsive disorder. Accordingly, infusion of food and beverage with mushroom compounds can provide a wide range of desired properties, benefits, and function, such as flavoring, functional, and psychoactive properties for addressing anxiety, depression, addiction, additional mental illnesses, and so forth.

With continued reference to FIG. 5, as shown in FIG. 5 (at 500), a suitable food grade oil such as coconut oil, MCT oil, another similar oil as described above, a combination of coconut oil and MCT oil, or a combination of two or more similar oils as described above, may be heated to a temperature equal to or between about 170° and 240° F. In an embodiment, the temperature may be equal to or between about 180° and 220° F. For the purposes of this specification, the term “about” used in relation to temperatures will mean within ±1%. Regarding a combination of coconut oil and MCT oil, an embodiment may be to use a ratio of 75% coconut oil to 25% MCT oil. Alternatively, ratios of coconut oil to MCT oil can range from any ratio of coconut oil to MCT oil, such as, but not limited to, 90% coconut oil: 10% MCT oil to 10% coconut oil: 90% MCT oil.

With continued reference to FIG. 5, next (at 504), the mushroom material (whole or parts of mushrooms) may be added to the food grade oil and held at the temperature between 170° and 240° F. for 4-12 hours (for instance, but not limited to, 6-9 hours), while occasionally (or continuously) stirring the mixture. In some embodiments, the ratio of mushroom material to good grade oil may be 1 lb. mushroom material to 2 gallons oil. However, other ratios within 10%, 20%, 30%, 40%, 50%, 75%, 100% of this ratio also may be used. In general, the ratio may be chosen to provide high levels/concentration(s) of mushroom compounds within the oil.

With continued reference to FIG. 5, after the heating step of 504, in the next step (at 508), the mushroom material and food grade oil mixture may be frozen to obtain a solid, frozen biomass of mushroom material and food grade oil mixture.

With continued reference to FIG. 5, at this juncture, the solid, frozen biomass of mushroom material and food grade oil can be processed in one of several ways. First, the frozen biomass can be heated and strained as per steps 512 and 516 (below) to yield mushroom compounds infused food grade oil produced by a single cycle or phase of heating and freezing. Second, the frozen biomass alternatively can be treated with a second cycle or phase of heating and freezing, in which steps 504 and 508 are repeated, followed by subsequent steps 512 and 516 to yield mushroom compounds infused food grade oil produced by two cycles of heating and freezing. Third, the second cycle treatment can be followed by a third cycle or phase of heating and freezing, in which steps 504 and 508 are repeated twice, followed by subsequent steps 512 and 516 to yield mushroom compounds infused food grade oil produced by three cycles of heating and freezing. Fourth, following a third cycle, the frozen biomass can be treated by a fourth cycle or phase of heating and freezing, in which steps 504 and 508 are repeated three times, followed by heating the frozen biomass and straining it as per steps 512 and 516 to yield mushroom compounds infused food grade oil produced by four cycles or phases of heating and freezing.

With continued reference to FIG. 5, single cycle/phase treatment may produce mushroom compounds infused food grade oil having a lesser relative level of infused mushroom compounds compared to a double cycle/phase treatment that may yield a greater level of infused mushroom compounds. For some particular applications, a third and/or fourth cycle treatment may yield an even greater level of infused mushroom compounds than a single or double cycle treatment. In an embodiment, a three-cycle treatment may be used.

With continued reference to FIG. 5, following step 508, at step 512, the solid, frozen mushroom and food grade oil biomass may be reheated to 150° to 200° F. and held at the temperature for a sufficient period of time to liquify the mixture, for instance, but not limited to, for about 2-4 hours.

With continued reference to FIG. 5, next (at 516), the mushroom and food grade oil mixture may be strained using a press bag (or other suitable straining techniques) to separate the mushroom compounds infused food grade oil from the mushroom biomass.

With continued reference to FIG. 5, this method may result in a whole spectrum mushroom compounds infused food grade oil that may be used in combination with a whole spectrum cannabis compounds infused food grade oil for infusing consumables, as described below. The infused food grade oil may be referred to as a mushroom extract.

As detailed below, food grade oil infused with cannabis compounds, naturally-occurring substance(s) compounds, and mushroom compounds may be used to infuse consumables with whole spectrum cannabis compounds, whole spectrum naturally-occurring substance(s) compounds, and whole spectrum mushroom compounds. In an embodiment, independently produced cannabis compounds infused food grade oil may be combined with independently produced naturally-occurring substance(s) compounds infused food grade oil and mushroom compounds infused food grade oil, and the combination of the three infused food grade oils may be used to infuse consumables (as outlined in FIG. 1). In this scenario, the three separate infused oils can be combined in any of a range of ratios to produce desired infused levels of cannabis compounds, naturally-occurring substance(s) compounds, and mushroom compounds in consumables. Examples of such ratios include, but are not limited to, 90% cannabis compounds infused food grade oil: 5% naturally-occurring substances compounds infused food grade oil: 5% mushroom compounds infused food grade oil; 5% cannabis compounds infused food grade oil: 5% naturally-occurring substances compounds infused food grade oil: 90% mushroom compounds infused food grade oil; to 5% cannabis compounds infused food grade oil: 90% naturally-occurring substances compounds infused food grade oil: 5% mushroom compounds infused food grade oil. In an embodiment, an equal ratio of one-third of each infused food grade oil may be used.

In an alternative embodiment, independently produced naturally-occurring substance(s) compounds infused food grade oil may be initially combined with mushroom compounds infused food grade oil, and that combination food grade oil may be then combined with independently produced cannabis compounds infused food grade oil. Other stepwise combinations of infused oils likewise may be used in the methods described herein. Virtually any stepwise combination of the three different infused food grade oils as well as any range of ratios of the three different infused food grade oils may be used as desired to produce a food grade oil that has a combination of whole spectrum cannabis compounds, whole spectrum other naturally-occurring substance(s) compounds, and whole spectrum mushroom compounds.

In an alternative embodiment, an infused food grade oil containing whole spectrum cannabis compounds, whole spectrum naturally-occurring substance(s) compounds, and whole spectrum mushroom may be produced in a stepwise manner by infusing a food grade oil with a first starting material; infusing that single infused oil with a second starting material to produce a double infused oil; and finally infusing that double infused oil with a third starting material to yield a triple infused food grade oil. For example, a food grade oil can be initially infused with cannabis; followed by infusion of that cannabis infused oil with a naturally-occurring substance(s) to yield a food grade oil double infused with cannabis and naturally-occurring substance(s) compounds; and then infusing that double infused food grade oil with mushrooms to yield a food grade oil triple infused with compounds from cannabis, naturally-occurring substance(s), and mushrooms. Note that in this scenario, each stepwise infusion method will be as specified above for independent infusion with cannabis, other naturally-occurring substance(s), and mushrooms, respectively.

In yet another alternative embodiment, the cannabis, naturally-occurring substances, and mushroom compounds infused food grade oil may be produced in an overall one-step process by simultaneously infusing an oil with cannabis, other naturally-occurring substance(s), and mushroom compounds, as outlined in FIG. 2. In this scenario, a cannabis, other naturally-occurring substance(s), and mushroom compounds infused food grade oil may be produced by combining cannabis, other naturally-occurring substance(s), and mushroom starting materials and then infusing a food grade oil. The process for infusing food grade oil with combined cannabis, other naturally-occurring substance(s), mushroom materials can be performed as described for producing cannabis infused food grade oil and outlined in FIG. 3 or can be performed as described for producing other naturally-occurring substance(s) food grade oil (as outlined in FIG. 4) or in the method for mushroom infused food grade oil (as outlined in FIG. 5). A food grade oil produced in the overall one-step process using combined cannabis and mushroom starting material may be produced by the process described above for producing cannabis infused food grade oil and outlined in FIG. 3.

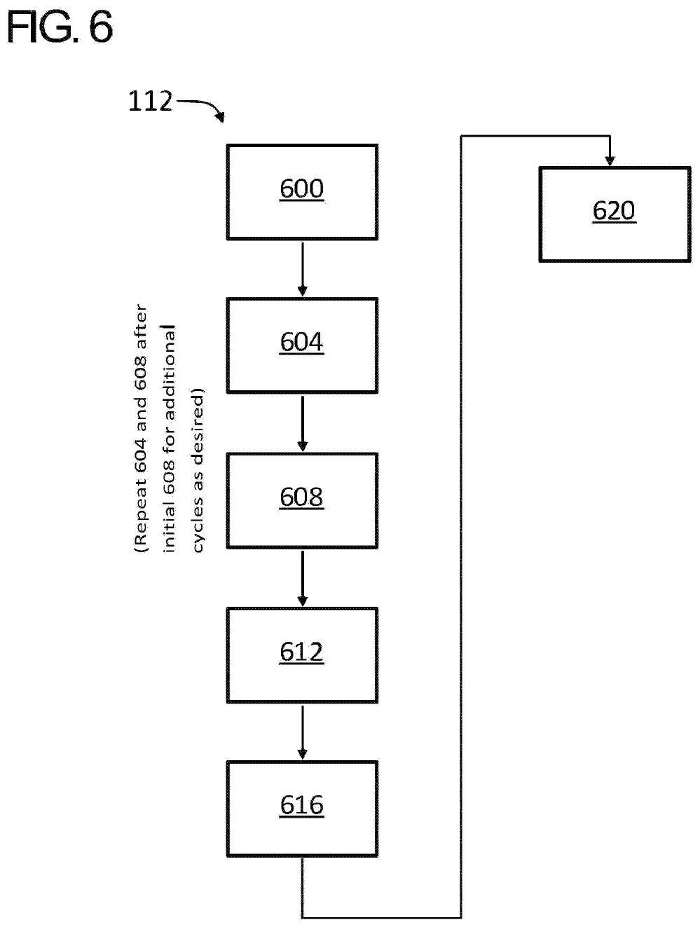

Referring now to FIG. 6, after a cannabis, other naturally-occurring substance(s), and mushroom whole spectrum compounds infused food grade oil has been produced, in an embodiment outlined in FIG. 6, the whole spectrum cannabis compounds, whole spectrum other naturally-occurring substance(s) compounds, and whole spectrum mushroom compounds infused food grade oil may be used to infuse consumables, such as, but not limited to, coffee beans, cacao beans, dehydrated fruit, and raw popcorn kernels with whole spectrum cannabis and mushroom compounds to complete step 112 of FIG. 1.

With continued reference to FIG. 6, first (at 600), at least a portion of the cannabis, other naturally-occurring substance(s), and mushroom compounds infused oil (as produced above) may be heated to a first temperature between about 170° F. and 240° F.

With continued reference to FIG. 6, next (at 604), a selection of consumables may be added and stirred into the infused food grade oil (for instance, but not limited to, with continuous stirring) and held at the first temperature of about 170° F. to 240° F. for about 4-12 hours, with inner time ranges of 5-6 or 6-9 hours. For the purposes of this specification, the term “about” used in relation to periods of time will mean±3%.

With continued reference to FIG. 6, next (at 608), the mixture of the consumable and infused oil may be frozen into a solid, frozen biomass. At this juncture, the solid, frozen biomass of infused food grade oil and consumable can be processed in one of several ways.

First, the infused food grade oil and consumable can be heated, strained, and frozen or packaged as per steps 612, 616, and 620 (below) to yield a cannabis, other naturally-occurring substance(s), and mushroom compounds infused consumable produced by a single round or phase of heating and freezing. Second, the infused food grade oil and consumable alternatively can be treated with a second cycle or phase of heating and freezing, in which steps 604 and 608 are repeated, followed by subsequent steps 408, 616, and 620 to yield a cannabis, other naturally-occurring substance(s), mushroom compounds infused consumable produced by two cycles of heating and freezing. Third, the second cycle treatment can be followed by a third cycle or phase of heating and freezing, in which steps 604 and 608 are repeated twice.

Following a third cycle, the frozen biomass can be heated and strained as per steps 612 and 616 to yield a cannabis, other naturally-occurring substance(s), and mushroom compounds infused consumable produced by three cycles or phases of heating and freezing.

With continued reference to FIG. 6, single cycle/phase treatment may produce a cannabis, other naturally-occurring substance(s), and mushroom compounds infused consumable having a lesser relative level of infused cannabis, other naturally-occurring substance(s), and mushroom compounds compared to a double cycle/phase treatment that may yield a greater level of infused mushroom compounds. For some particular applications and desired infusion levels, a third cycle treatment may yield an even greater level of infused cannabis, other naturally-occurring substance(s), and mushroom compounds than a single or double cycle treatment.

With continued reference to FIG. 6, following step 608, at step 612, the mixture including the now infused consumable and infused food grade oil may be heated to a temperature equal to or between 150° F. and 200° F. and held at the temperature for a sufficient period of time to liquify the food grade oil, for instance, but not limited to, about 2-4 hours, and for about 2 hours.

With continued reference to FIG. 6, after this heating step at 612, the mixture may be strained at step 616 (using any suitable straining techniques) and the whole spectrum cannabis compounds, whole spectrum other naturally-occurring substance(s) compounds, and whole spectrum mushroom compounds infused consumables are removed from the food grade oil.

With continued reference to FIG. 6, then (at 620), the whole spectrum cannabis compounds, whole spectrum other naturally-occurring substance(s) compounds, and whole spectrum mushroom compounds infused consumables may be frozen and stored frozen for subsequent use/packaging/consumption. Alternatively, the cannabis, other naturally-occurring substance(s), and mushroom compounds infused consumables can be directly used, packaged, or consumed without freezing.

With continued reference to FIG. 6, this process 600-620 (FIG. 6) may result in a food consumable infused with whole spectrum cannabis compounds, whole spectrum other naturally-occurring substance(s) compounds, and whole spectrum mushroom compounds, which can be referred to as a cannabis, other naturally-occurring substance(s), and mushroom compounds infused consumable.

With continued reference to FIG. 6, in some embodiments, the freezing step at 608 may provide organic pressure to the coffee beans, cacao beans, dehydrated fruit, raw popcorn kernels, or other consumables that deepens the physical depth of the cannabis, other naturally-occurring substance(s), and mushroom compounds infusion into the consumables. For example, in some embodiments, the freezing step at 608 may cause the cannabis compounds, other naturally-occurring substance(s) compounds, and mushroom compounds to be pressed 10%, 20%, 30%, 40%, 50%, 60%, 70%, 80%, 90% and/or 100% to the centers of the coffee beans, cacao beans, dehydrated fruit, raw popcorn kernels, or other consumables.

It is understood that the acts described above are meant as a general overview and demonstration of an exemplary method, and that the method may include different and/or additional acts as described herein or otherwise.

While the present invention has been described as having particular configurations disclosed herein, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

It is understood that any aspect and/or element of any embodiment of the method(s) described herein or otherwise may be combined in any way to form additional embodiments of the method(s) all of which are within the scope of the method(s).

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation.

Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and I or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and embodiments and is further described in the examples below, it is to be understood that the invention is not to be limited to the disclosed embodiment, but on the contrary, is intended to cover various modifications and equivalent arrangements included within the spirit and scope of the appended claims.

### Example I: Coffee Beans

Cannabis, other naturally-occurring substance(s), and mushroom compounds infused roasted coffee beans may be made by infusing roasted coffee beans with a cannabis, other naturally-occurring substance(s), and mushroom compounds infused food grade oil obtained as described above and outlined in FIGS. 1-6.

In an embodiment, cannabis and mushroom compounds infused roasted coffee beans may be made by infusing roasted coffee beans with a cannabis, other naturally-occurring substance(s), and mushroom compounds infused food grade oil as described in the process 500-516. The heating steps described in the process 500-516 for infusing roasted coffee beans may be carried out at a temperature between 175° F. and 185° F. Once the cannabis, other naturally-occurring substance(s), and mushroom compounds infused roasted coffee beans are obtained, they can be stored frozen to help preserve freshness and slow/prevent deterioration of the cannabis, other naturally-occurring substance(s), and mushroom compounds that reduces the efficacy of the compounds. The infused roasted coffee beans can be used to make cannabis, other naturally-occurring substance(s), and mushroom compounds infused coffee beverage(s).

### Example II: Cacao Beans

The process by which cacao beans are infused with cannabis, other naturally-occurring substance(s), and mushroom compounds follows the processes described above and outlined in FIGS. 1-6. Once the cannabis, other naturally-occurring substance(s), and mushroom compounds infused cacao beans are obtained, they can be stored frozen to help preserve freshness and slow/prevent deterioration of the cannabis, other naturally-occurring substance(s), and mushroom compounds that reduces the efficacy of the cannabis, other naturally-occurring substance(s), and mushroom compounds.

The cannabis, other naturally-occurring substance(s), and mushroom compounds infused cacao beans can be processed in any of a variety of methods similar to standard cacao beans (which are not infused) to produce cannabis, other naturally-occurring substance(s), and mushroom compounds infused cacao and chocolate products, such as but not limited to, hot chocolate beverage, chocolate chips, chocolate bars, chocolate bars with nuts and fruit, chocolate bars with nougat, and so on. In an embodiment, cannabis, other naturally-occurring substance(s), and mushroom compounds infused chocolate bars with nuts and/or dehydrated fruits are made with chocolate from cannabis, other naturally-occurring substance(s), and mushroom compounds infused cacao beans along with cannabis, other naturally-occurring substance(s), and mushroom compounds infused nuts and/or dehydrated fruits that are produced by the methods disclosed herein. Such chocolate bars made with cannabis, other naturally-occurring substance(s), and mushroom compounds infused chocolate and nuts and/or dehydrated fruits have a greater level of cannabis, other naturally-occurring substance(s), and mushroom compounds and therefore potency than chocolate bars made solely with cannabis, other naturally-occurring substance(s), and mushroom compounds infused chocolate with nuts and/or fruits that are not infused.

### Example III: Popcorn

Cannabis, other naturally-occurring substance(s), and mushroom compounds infused popcorn kernels may be made by infusing popcorn kernels with a cannabis, other naturally-occurring substance(s), and mushroom compounds infused food grade oil obtained as described above and outlined in FIGS. 1-6.

To infuse popcorn kernels with cannabis, other naturally-occurring substance(s), and mushroom compounds from a cannabis, other naturally-occurring substance(s), and mushroom compounds infused food grade oil, raw kernels are added to infused food grade oil at a temperature between 150° F. and 200° F. (for instance, but not limited to, 170° F.) in the process described above and in FIG. 6. The infused kernels can then be used directly for popcorn or can be treated using methods that impart various flavors and/or seasoning to the popcorn. Infused kernels that are to be used directly for popcorn may be stored in a cooking oil, for instance, but not limited to, at about a 1:1 kernels to oil ratio. The infused kernels can then be popped directly from the stored mixture.

### Example IV: Infused Dehydrated Fruit

The process by which dehydrated fruit may be infused with cannabis, other naturally-occurring substance(s), and mushroom compounds follows the processes described above and outlined in FIGS. 1-6.

Virtually any dehydrated fruit can be used in the cannabis, other naturally-occurring substance(s), and mushroom compounds infusion process, such as, but not limited to, dehydrated strawberries, other berries, cherries, apricots, mangos, grapes (raisins), cranberries, prunes, and so forth. Once the cannabis, other naturally-occurring substance(s), and mushroom compounds infused dehydrated fruit may be obtained, the fruit can be stored frozen to help preserve freshness and slow/prevent deterioration of the cannabis, other naturally-occurring substance(s), and mushroom compounds that reduces the efficacy of the cannabis, other naturally-occurring substance(s), and mushroom compounds. The cannabis, other naturally-occurring substance(s), and mushroom compounds infused dehydrated fruit can be consumed directly or used in the preparation of various foods that contain dehydrated fruit, such as granola bars, chocolate bars, baked goods, trail mix, and the like. When used in the preparation of other foods, the cannabis, other naturally-occurring substance(s), and mushroom compounds infused dehydrated fruit will provide a source of whole spectrum cannabis, other naturally-occurring substance(s), and mushroom compounds to such foods.

### Example V: Infused Raw Fruit

The process by which raw fruit may be infused with cannabis, other naturally-occurring substance(s), and mushroom compounds generally follows the processes described above and outlined in FIGS. 1-6, with some modifications. In an embodiment, MCT oil may be used as the infused oil may be used, given its relatively low melting/liquifying temperature.

To infuse raw fruit, the raw fruit may be mixed with the cannabis, other naturally-occurring substance(s), and mushroom compounds infused oil at a temperature between about 100° F. and 150° F. for 15 minutes to one hour. The mixture of infused oil and fruit may be then frozen solid. Following the freezing, the mixture may be liquified at a temperature between about 100° F. and 150° F. and then the fruit may be separated from the oil using an acceptable straining method, such as straining through a nylon mesh filter. The type of raw fruit used in this process may include a relatively high density that helps keep the fruit intact throughout the process. For example, pineapple and mango are fruits that have been used in this process to produce cannabis, other naturally-occurring substance(s), and mushroom compounds infused pineapple and mango. The infused fruits can be stored frozen to help preserve the integrity of the cannabis, other naturally-occurring substance(s), and mushroom compounds. The infused fruits can be consumed directly or used in other foods, such as the aforementioned chocolate and granola bars.

### Example VI: Infused Raw Vegetables

The process by which raw vegetables are infused with cannabis, other naturally-occurring substance(s), and mushroom compounds generally follows the processes described above and outlined in FIGS. 1-6, with some modifications. In an embodiment, MCT oil may be used as the infused oil may be used, given its relatively low melting/liquifying temperature.

To infuse raw vegetable(s), the raw vegetable(s) are mixed with the cannabis, other naturally-occurring substance(s), and mushroom compounds infused oil at a temperature between about 100° F. and 150° F. for 15 minutes to one hour. The mixture of infused oil and vegetables may be then frozen solid. Following the freezing, the mixture may be liquified at a temperature between about 100° F. and 150° F. and then the vegetables are separated from the oil using an acceptable straining method, such as straining through a nylon mesh filter. The type of raw vegetable(s) used in this process may have a relatively high density that helps keep the vegetables intact throughout the process. The infused vegetables can be stored frozen to help preserve the integrity of the cannabis, other naturally-occurring substance(s), and mushroom compounds. The infused vegetables can be consumed directly or used in other foods.

### Example VII: Raw and Roasted Nuts and Seeds

Cannabis, other naturally-occurring substance(s), and mushroom compounds infused raw or roasted nuts and seeds may be made by infusing raw or roasted nuts and seeds with a cannabis, other naturally-occurring substance(s), and mushroom compounds infused food grade oil obtained as described above and outlined in FIGS. 1-6.

To infuse raw nuts and seeds or roasted nuts and seeds with cannabis, other naturally-occurring substance(s), and mushroom compounds from a cannabis, other naturally-occurring substance(s), and mushroom compounds infused oil, the consumables are added to infused oil at a temperature between 150° F. and 200° F. (for instance, but not limited to, 170° F.) in the process described above and in FIG. 4. The infused nuts and seeds can then be consumed directly or used in other foods, such chocolate and granola bars, trail mix, and so forth.

### Example VIII: Granola Bars

Cannabis, other naturally-occurring substance(s), and mushroom compounds infused granola bars can be made using suitable cannabis, other naturally-occurring substance(s), and mushroom compounds infused food grade oil as infused using the infusion processes described above and outlined in FIGS. 1-6.

Once a suitable cannabis, other naturally-occurring substance(s), and mushroom compounds infused oil may be produced, the infused oil can be used as a base for granola bars. The bars can be made with a variety of cannabis, other naturally-occurring substance(s), and mushroom compounds infused nuts and/or seeds that are formed into granola bars with oatmeal (that likewise can be infused with cannabis, other naturally-occurring substance(s), and mushroom compounds) or a similar foodstuff that may be used in granola bars. Such granola bars formed in this manner can contain a significant number of cannabis, other naturally-occurring substance(s), and mushroom compounds.

### Example IX: Infused Garlic and Beans

Cannabis, other naturally-occurring substance(s), and mushroom compounds infused garlic and beans (such as pinto beans, navy beans, and other similar beans) can be made using a suitable cannabis and mushroom compounds infused food grade oil infused with cannabis, other naturally-occurring substance(s), and mushroom compounds using the infusion processes described above and outlined in FIGS. 1-6.

The process by which garlic or beans are infused with cannabis, other naturally-occurring substance(s), and mushroom compounds closely follows the general process described above. The heating steps described in the process 600-620 (FIG. 6) for infusing garlic and beans may be carried out at a temperature between 150° F. and 170° F. for 3-4 hours. Once the cannabis, other naturally-occurring substance(s), and mushroom compounds infused garlic or beans are obtained, the garlic or beans can be stored frozen to help preserve freshness and slow/prevent deterioration of the cannabis, other naturally-occurring substance(s), and mushroom compounds that reduces the efficacy of the cannabis, other naturally-occurring substance(s), and mushroom compounds.

### Example X: Infused Bacon

Cannabis, other naturally-occurring substance(s), and mushroom compounds infused bacon can be made using a suitable cannabis, other naturally-occurring substance(s), and mushroom compounds infused good grade oil made with the oil infusion processes described above and outlined in FIGS. 1-6.

Once a suitable cannabis, other naturally-occurring substance(s), and mushroom compounds infused oil m a y b e produced, the infused oil can be used to infuse bacon with cannabis, other naturally-occurring substance(s), and mushroom compounds. To infuse bacon, raw bacon may be initially laid out on a baking pan or similar baking sheet that has raised edges. The bacon may be then coated with the cannabis, other naturally-occurring substance(s), and mushroom compounds infused oil, along with a sufficient amount of infused oil to keep a layer of infused oil in the bottom of the baking pan to ensure that the bacon may be exposed to the infused oil. The bacon with infused oil may be then frozen solid. After freezing, the bacon with infused oil may be heated to a temperature between 170° F. and 250° F. for 1-4 hours or until the bacon is crisp. The resulting cannabis and mushroom compounds infused bacon may be then strained from the cannabis, other naturally-occurring substance(s), and mushroom compounds infused oil and resulting cannabis, other naturally-occurring substance(s), and mushroom compounds infused bacon grease (such that there may be a cannabis, other naturally-occurring substance(s), and mushroom compounds infused oil and bacon grease mixture). The bacon may be then stored for subsequent use, either frozen or at a refrigerated/cool temperature.

The resulting cannabis, other naturally-occurring substance(s), and mushroom compounds infused oil and bacon grease mixture may be a bacon flavored mixture that can be used in the methods disclosed herein to infuse consumables with cannabis, other naturally-occurring substance(s), and mushroom compounds and impart/add a bacon flavor to the consumable. For example, the cannabis, other naturally-occurring substance(s), and mushroom compounds infused oil and bacon grease mixture can used to prepare popcorn as detailed above, resulting in a cannabis, other naturally-occurring substance(s), and mushroom compounds infused, bacon flavored popcorn.

### Example XI: Infused, Flavored Oil

As detailed above, cannabis, other naturally-occurring substance(s), and mushroom compounds infused food grade oils can be produced using essentially all food grade oils and butter, including but not limited to, coconut oil, butter, MCT oil, shortening, lard, vegetable oil, sunflower oil, olive oil, grape seed oil, avocado oil, and combinations thereof. Any of these oils and butter can be infused with cannabis, other naturally-occurring substance(s), and mushroom compounds using the oil infusion processes described above and outlined in FIGS. 1-6. Cannabis, other naturally-occurring substance(s), and mushroom compounds infused oils and butter can be used to infuse various consumables by the methods described above and outlined in FIG. 6 as well as the various specific examples described herein, such as those for infused raw fruit, bacon, garlic, and so on. The methods described herein may also be used to produce infused cooking flavoring agents, such as herbs and spices. Such cannabis, other naturally-occurring substance(s), and mushroom compounds infused, flavoring agents (herbs and spices) can be used on food to provide cannabis, other naturally-occurring substance(s), and mushroom compounds and flavor.

Once a cannabis, other naturally-occurring substance(s), and mushroom compounds consumable may be produced by the methods described herein, the residual cannabis, other naturally-occurring substance(s), and mushroom compounds infused food grade oil can be used in the process again since the residual infused oil still contains a significant amount of cannabis, other naturally-occurring substance(s), and mushroom compounds. In this manner, residual infused oil can be used in the process once or twice, such that infused oil can overall be used 2-3/several times in the process.

Another aspect of the residual cannabis, other naturally-occurring substance(s), and mushroom compounds infused oil may be that the oil acquires/takes on flavor from the infused consumable. As indicated above, the process used to infuse bacon with cannabis, other naturally-occurring substance(s), and mushroom compounds produces a residual cannabis, other naturally-occurring substance(s), and mushroom compounds infused, bacon flavored oil and bacon grease mixture. The processes used to infuse other consumables likewise results in a flavored, cannabis, other naturally-occurring substance(s), and mushroom compounds infused oil. For example, the residual oil from the process used to produce cannabis, other naturally-occurring substance(s), and mushroom compounds infused garlic will have a garlic flavor; residual oil from cannabis, other naturally-occurring substance(s), and mushroom compounds infused fruit will have a fruit flavor; residual oil from cannabis, other naturally-occurring substance(s), and mushroom compounds infused with coffee will have a coffee flavor; and so on. The flavored, cannabis, other naturally-occurring substance(s), and mushroom compounds infused oils can be used to impart both flavors along with cannabis, other naturally-occurring substance(s), and mushroom compounds to other foods in several ways, such as, but not limited to, by directly using the infused oil on food, as a cooking oil, in the infusion methods disclosed herein, and so forth.

### Example XII: Ice Cream, Jams, and Jellies with Infused Fruit

As detailed above, cannabis, other naturally-occurring substance(s), and mushroom compounds infused fresh and dehydrated fruits can be produced by methods disclosed herein. Such cannabis, other naturally-occurring substance(s), and mushroom compounds infused fruits can in turn be used in ice cream, jams, and jellies to produce cannabis, other naturally-occurring substance(s), and mushroom compounds infused, flavored ice cream, jams, and jellies. For example, cannabis, other naturally-occurring substance(s), and mushroom compounds infused fresh fruit can be used to make a slurry that in turn can be used in making ice cream, jams, or jellies, resulting in cannabis, other naturally-occurring substance(s), and mushroom compounds infused and flavored ice cream, jams, or jellies. The cannabis, other naturally-occurring substance(s), and mushroom compounds content of such products can be increased by adding other cannabis, other naturally-occurring substance(s), and mushroom compounds infused consumables, such as cannabis, other naturally-occurring substance(s), and mushroom compounds infused nuts and/or chocolate.

### Example XIII: Caramel Sauce

As detailed above, cannabis, other naturally-occurring substance(s), and mushroom compounds infused food grade oil can be produced by the methods disclosed herein. Such oil can in turn be added to caramel sauce to produce a cannabis, other naturally-occurring substance(s), and mushroom compounds containing caramel sauce. A cannabis, other naturally-occurring substance(s), and mushroom compounds containing caramel sauce can be used in the production of ice cream to add cannabis, other naturally-occurring substance(s), and mushroom compounds into the ice cream. Alternatively, a cannabis, other naturally-occurring substance(s), and mushroom compounds containing caramel sauce can be used as a topping, a flavoring agent/ingredient for other foods, and so forth. In this regard, cannabis, other naturally-occurring substance(s), and mushroom compounds containing caramel sauce can be used to add both flavor along with cannabis, other naturally-occurring substance(s), and mushroom compounds to a variety of consumables.

### Example XIV: Baked Goods

As detailed above, cannabis, other naturally-occurring substance(s), and mushroom compounds infused food grade oil can be produced by the methods disclosed herein. Such infused oil can in turn be used to make various baked goods, such as cookies, brownies, quick breads, and so forth. In this regard, cannabis, other naturally-occurring substance(s), and mushroom compounds infused oil can be added as a base ingredient for baked goods, such as the food grade oil in baked goods or in combination with other base ingredients, such as butter. In one exemplary embodiment, a ratio of 75% cannabis, other naturally-occurring substance(s), and mushroom compounds infused oil to 25% cannabis, other naturally-occurring substance(s), and mushroom compounds infused butter may be used as a base ingredient in making cookies, brownies, and other baked goods.

### Example XV: Freeze Dried Consumables

As detailed above, cannabis, other naturally-occurring substance(s), and mushroom compounds infused food grade oil can be produced by the methods disclosed herein. Such infused oil can in turn be used to make a wide variety of various cannabis, other naturally-occurring substance(s), and mushroom compounds infused consumables, such as infused raw fruit, ice cream, and so forth. A wide variety of cannabis, other naturally-occurring substance(s), and mushroom compounds infused consumables can in turn be treated by the process of lyophilization, also called as freeze-drying, to turn the cannabis, other naturally-occurring substance(s), and mushroom compounds infused consumables into another form of consumable. Lyophilization may remove 98% of the original water content, resulting in a crunchy and/or creamy consumable. Accordingly, the methods described herein can be applied to produce cannabis, other naturally-occurring substance(s), and mushroom compounds infused consumables that in turn are freeze-dried to produce freeze-dried cannabis, other naturally-occurring substance(s), and mushroom compounds infused consumables. The freeze-drying process allows foods such as infused fruit to retain both its cannabis, other naturally-occurring substance(s), and mushroom compounds and its nutrition.

### Example XVI: Pressure Cooked Infused Consumables

As detailed above, cannabis, other naturally-occurring substance(s), and mushroom compounds infused food grade oil can be produced by the methods disclosed herein. Such infused oil can in turn be used to make a wide variety of various cannabis, other naturally-occurring substance(s), and mushroom compounds infused consumables by methods that include heating and freezing steps to infuse the consumables with cannabis, other naturally-occurring substance(s), and mushroom compounds, as described above. In an exemplary embodiment, the heating steps may be carried out under pressure, such as in a pressure cooker. In this regard, the levels of infused cannabis, other naturally-occurring substance(s), and mushroom compounds in an infused consumable produced with pressure cooking can be greater than the relative levels obtained without pressure cooking. Accordingly, pressure cooking, or similar pressurized heating can be used to produce consumables that potentially have even higher levels of infused cannabis, other naturally-occurring substance(s), and mushroom compounds when compared to the infused consumables produced by the methods disclosed herein.

In some embodiments, compounds from cannabis, naturally-occurring substances and mushrooms may be infused with non-consumables. As a non-limiting example, non-consumable may include hair care products, skin care products, or the like. Additional disclosure related to infusing compounds to consumables and non-consumables may be found in U.S. Non-provisional patent application Ser. No. 17/039,829, filed on Sep. 30, 2020, and titled “CANNABINOIDS INFUSED CONSUMABLES AND NON-CONSUMABLES,” having an attorney docket number of 1567-003USU1, which is incorporated by reference herein in its entirety.

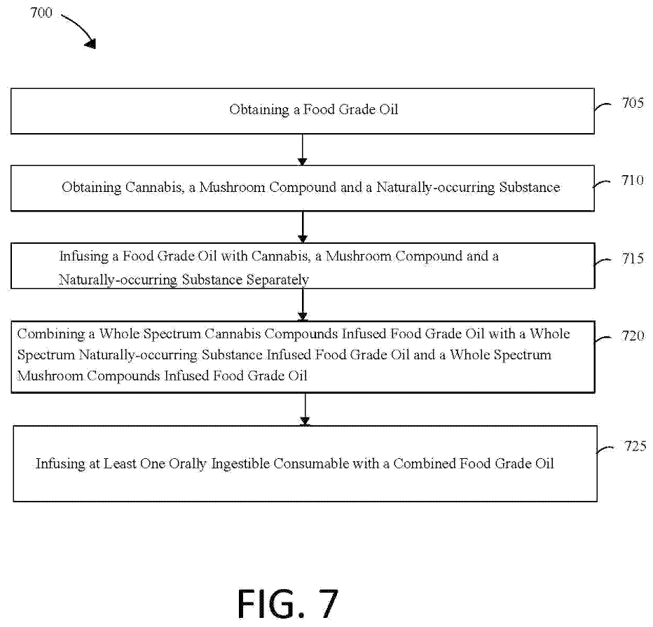

Referring now to FIG. 7, a flow diagram of another exemplary method 700 of producing consumables infused with compounds from cannabis, naturally-occurring substances and mushrooms is illustrated. Method 700 includes a step 705 of obtaining a food grade oil. In some embodiments, method 700 may further include providing the food grade oil at a temperature of 170° F.-240° F. These may be implemented with reference to FIGS. 1-6.

With continued reference to FIG. 7, method 700 includes a step 710 of obtaining cannabis, a mushroom compound and a naturally-occurring substance. These may be implemented with reference to FIGS. 1-6.

With continued reference to FIG. 7, method 700 includes a step 715 of infusing a food grade oil with cannabis, a mushroom compound and a naturally-occurring substance, wherein infusing further includes infusing a first food grade oil of the food grade oil with the cannabis to yield a whole spectrum cannabis compounds infused food grade oil, infusing a second food grade oil of the food grade oil with the mushroom compound to yield a whole spectrum mushroom compounds infused food grade oil and infusing a third food grade oil of the food grade oil with the naturally-occurring substance to yield a whole spectrum naturally-occurring substance infused food graded oil. In some embodiments, infusing the first food grade oil of the food grade oil with the cannabis may further include freezing the cannabis to yield frozen cannabis and adding at least a portion of the frozen cannabis to the food grade oil to form a cannabis and food grade oil mixture. In some embodiments, infusing the food grade oil with the cannabis, the mushroom compound and the naturally-occurring substance may further include heating a mixture to a temperature of 170° F.-240° F. for 4-12 hours, wherein the mixture may be one of the cannabis and food grade oil mixture, a mushroom and food grade oil mixture, a naturally-occurring substance and food grade oil mixture and a consumable and infused oil mixture. In some embodiments, infusing the food grade oil with the cannabis, the mushroom compound and the naturally-occurring substance may further include freezing the mixture into a solid biomass. In some embodiments, infusing the food grade oil with the cannabis, the mushroom compound and the naturally-occurring substance may further include heating the solid biomass at a temperature of 150° F.-200° F. for 2-4 hours. In some embodiments, infusing the first food grade oil of the food grade oil with the cannabis may further include straining the heated solid biomass to separate the food grade oil from the cannabis to yield the whole spectrum cannabis compounds infused food grade oil. These may be implemented with reference to FIGS. 1-6.

With continued reference to FIG. 7, method 700 includes a step 720 of combining a whole spectrum cannabis compounds infused food grade oil with a whole spectrum naturally-occurring substance infused food grade oil and a whole spectrum mushroom compounds infused food grade oil to yield a combined food grade oil. In some embodiments, method 700 may further include heating the whole spectrum cannabis compounds infused food grade oil to a temperature of 250° F.-300° F. for 1-6 hours. In some embodiments, method 700 may further include cooling the heated whole spectrum cannabis compounds infused food grade oil to a temperature of 150° F.-200° F. These may be implemented with reference to FIGS. 1-6.

With continued reference to FIG. 7, method 700 includes a step 725 of infusing at least one orally ingestible consumable with a combined food grade oil. In some embodiments, infusing the at least one orally ingestible consumable with the combined food grade oil may further include adding the at least one orally ingestible consumable to the combined food grade oil to form a consumable and infused oil mixture. In some embodiments, method 700 may further include heating the consumable and infused oil mixture to a temperature of 170° F.-240° F. for 4-12 hours. In some embodiments, method 700 may further include freezing the heated consumable and infused oil mixture to form a solid, frozen mixture of consumable and infused oil. In some embodiments, method 700 may further include heating the solid, frozen mixture of consumable and infused oil to a temperature of 150° F.-200° F. for 2-4 hours to liquify the infused oil. In some embodiments, method 700 may further include straining the orally ingestible consumable from the infused oil to yield a consumable infused with whole spectrum cannabis compounds, whole spectrum naturally occurring substance(s) compounds, and whole spectrum mushroom compounds. These may be implemented with reference to FIGS. 1-6.

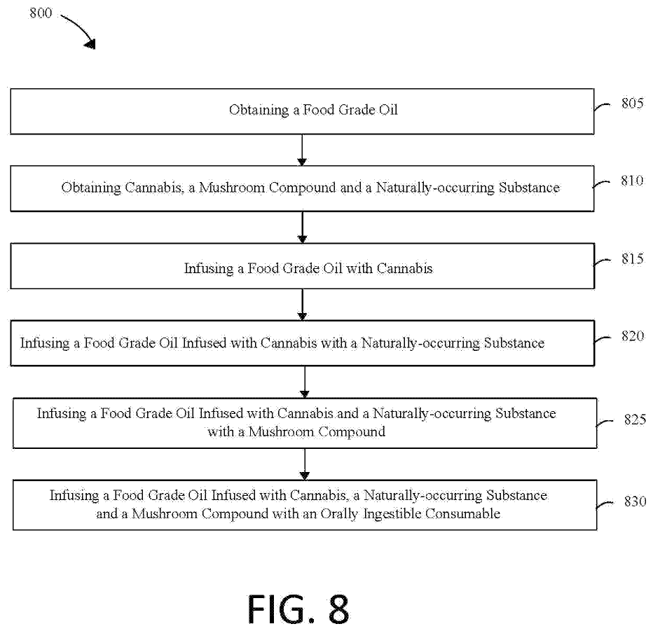

Referring now to FIG. 8, a flow diagram of another exemplary method 800 of producing consumables infused with compounds from cannabis, naturally-occurring substances and mushrooms. Method 800 includes a step 805 of obtaining a food grade oil. In some embodiments, method 700 may further include providing the food grade oil at a temperature of 170° F.-240° F. These may be implemented with reference to FIGS. 1-7.

With continued reference to FIG. 8, method 800 includes a step 810 of obtaining cannabis, a mushroom compound and a naturally-occurring substance. These may be implemented with reference to FIGS. 1-7.

With continued reference to FIG. 8, method 800 includes a step 815 of infusing a food grade oil with cannabis. These may be implemented with reference to FIGS. 1-7.

With continued reference to FIG. 8, method 800 includes a step 820 of infusing a food grade oil infused with cannabis with a naturally-occurring substance(s). These may be implemented with reference to FIGS. 1-7.

With continued reference to FIG. 8, method 800 includes a step 825 of infusing the food grade oil infused with cannabis and a naturally-occurring substance(s) with a mushroom compound. A food grade oil may be first infused with a single, first starting class of material. This first starting material compounds infused food grade oil may be next infused with a second starting class of starting material to yield a food grade oil double infused with compounds from the first and second classes of starting materials. In a third step the double infused food grade oil may be next infused with a third class of starting material to yield a food grade oil triple infused with compounds from the first, second, and third classes of starting materials. The classes of starting materials used in this embodiment may include cannabis, other naturally-occurring substance(s), and mushrooms. The food grade oil can be infused stepwise in any desired order of first, second, and third starting materials. These may be implemented with reference to FIGS. 1-7.

With continued reference to FIG. 8, method 800 includes a step 830 of infusing the food grade oil infused with cannabis, naturally-occurring substance(s) and mushroom compound with an orally ingestible consumable to yield a consumable infused with whole spectrum cannabis compounds, whole spectrum naturally-occurring substance compound and whole spectrum mushroom compound. These may be implemented with reference to FIGS. 1-7.

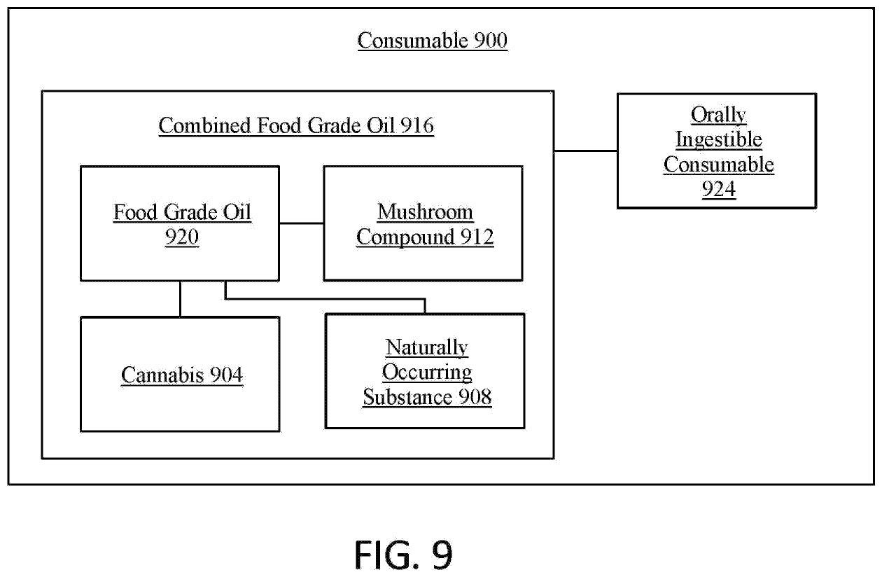

Referring now to FIG. 9, a block diagram of an exemplary consumable 900 infused with compounds from cannabis 904, other naturally-occurring substances 908 and mushroom compound 912 is illustrated. Consumable 900 may include cannabis 904. For the purposes of this disclosure, “cannabis” is a flowering plant in the Cannabaceae family. Cannabis 904 may be referred as ‘cannabis plant,’ ‘cannabis compound,’ ‘whole spectrum cannabis,’ ‘whole spectrum cannabis compound,’ or the like in this disclosure. In some embodiments, cannabis 904 may get frozen to yield frozen cannabis and at least a portion of the frozen cannabis may be added to combined food grade oil 916 to form a cannabis and food grade oil mixture. In some embodiments, a mixture may be heated to a temperature of 170° F.-240° F. for 4-12 hours, wherein the mixture may include either the cannabis and food grade oil mixture, a mushroom and food grade oil mixture or a naturally-occurring substance material and food grade oil mixture. In some embodiments, the mixture may get frozen into a solid biomass. In some embodiments, the solid biomass may be heated at a temperature of 150° F.-200° F. for 2-4 hours. In some embodiments, the heated mixture may get strained to separate the food grade oil from the cannabis to yield a whole spectrum cannabis compounds infused food grade oil. Cannabis may produce a variety of potentially useful or beneficial compounds, such as cannabinoids, which produce mental and physical effects when consumed. Additional disclosure related to infusing cannabinoids with consumables may be found in U.S. Non-provisional patent application Ser. No. 17/038,340, filed on Sep. 30, 2020, and titled “METHOD FOR MAKING CANNABINOIDS INFUSED CONSUMABLES,” having an attorney docket number of 1567-001USU1, which is incorporated by reference herein in its entirety. These may be implemented as described with respect to FIGS. 1-8.

With continued reference to FIG. 9, consumable 900 may include a mushroom compound 912. For the purposes of this disclosure, “mushroom” is a type of fungus. Mushroom compound 912 may be referred as ‘mushroom,’ ‘whole spectrum mushroom,’ ‘whole spectrum mushroom compound,’ or the like in this disclosure. These may be implemented as described with respect to FIGS. 1-8.

With continued reference to FIG. 9, consumable 900 may include naturally-occurring substances 908. As a non-limiting example, other naturally-occurring substances 908 may include, but are not limited to, sea mosses, barks (such as elderberry bark), roots (such as burdock root), mosses, black seed, herbs, hops, teas, and so forth. Other naturally-occurring substance 908 may be referred as ‘other naturally-occurring substance compound,’ ‘whole spectrum other naturally-occurring substance,’ ‘whole spectrum other naturally-occurring substance compound,’ or the like. These may be implemented as described with respect to FIGS. 1-8.

With continued reference to FIG. 9, consumable 900 includes a combined food grade oil 916. For the purposes of this disclosure, a “combined food grade oil” is a food grade oil infused with whole spectrum cannabis compounds, whole spectrum naturally-occurring substance compounds and whole spectrum mushroom compounds. For the purposes of this disclosure, a “food grade oil” is an edible oil that is safe for human consumption. As a non-limiting example, food grade oil 920 may include coconut oil, MCT oil, corn oil, vegetable oil, safflower oil, peanut oil, sunflower oil, soybean oil, sesame oil, canola oil, rapeseed oil, olive oil, cottonseed oil, or any food grade oil 920 described in this disclosure. Food grade oil 920 is infused with cannabis 904, mushroom compound 912 and naturally-occurring substance 908. “Naturally-occurring substance” disclosed herein is also mentioned as “other naturally-occurring substance” in this disclosure. A first food grade oil of food grade oil 920 is infused with cannabis 904 to yield a whole spectrum cannabis compounds infused food grade oil. A second food grade oil of food grade oil 920 is infused with the mushroom compound 912 to yield a whole spectrum mushroom compounds infused food grade oil. A third food grade oil of food grade oil 920 is infused with naturally-occurring substance 908 to yield a whole spectrum naturally-occurring substance infused food graded oil. Whole spectrum cannabis compounds infused food grade oil, whole spectrum naturally-occurring substance infused food grade oil and whole spectrum mushroom compounds infused food grade oil are combined to yield a combined food grade oil 916. In some embodiments, the food grade oil 920 may be provided at a temperature of 170° F.-240° F. In some embodiments, the whole spectrum cannabis compounds infused food grade oil may be heated to a temperature of 250° F.-300° F. for 1-6 hours. In some embodiments, the heated whole spectrum cannabis compounds infused food grade oil may get cooled to a temperature of 150° F.-200° F. In some embodiments, an orally ingestible consumable may be infused with cannabis 904, mushroom compound 912 and other naturally-occurring substance 908. These may be implemented as described with respect to FIGS. 1-8.

With continued reference to FIG. 9, consumable 900 includes at least one orally ingestible consumable 924. As a non-limiting example, orally ingestible consumable 924 may include coffee beans, cacao beans, popcorns, fruits, dehydrated fruits, vegetables, nuts, seeds, granola bars, energy bars, bacon, garlic, beans, ice cream, jams, jellies, caramel sauce, baked goods, or any consumables described in this disclosure. At least one orally ingestible consumable 924 is infused with a combined food grade oil 916. In some embodiments, infusing an orally ingestible consumable 924 with the combined food grade oil 916 may further include adding the at least one orally ingestible consumable 924 to the combined food grade oil to form a consumable and infused oil mixture. In some embodiments, method 700 may further include heating the consumable and infused oil mixture to a temperature of 170° F.-240° F. for 4-12 hours. In some embodiments, method 700 may further include freezing the heated consumable and infused oil mixture to form a solid, frozen mixture of consumable and infused oil. In some embodiments, method 700 may further include heating the solid, frozen mixture of consumable and infused oil to a temperature of 150° F.-200° F. for 2-4 hours to liquify the infused oil. In some embodiments, method 700 may further include straining the orally ingestible consumable from the infused oil to yield a consumable infused with whole spectrum cannabis compounds, whole spectrum naturally occurring substance(s) compounds, and whole spectrum mushroom compounds. These may be implemented as described with respect to FIGS. 1-8.

What is claimed is:

1. A method of producing consumables infused with compounds from cannabis, naturally-occurring substances and mushrooms, the method comprising:
obtaining a food grade oil;
obtaining cannabis, a mushroom compound, and a naturally-occurring substance;
infusing the food grade oil with the cannabis, the mushroom compound and the naturally-occurring substance, wherein infusing further comprises:
infusing a first food grade oil of the food grade oil with the cannabis to yield a whole spectrum cannabis compounds infused food grade oil;
infusing a second food grade oil of the food grade oil with the mushroom compound to yield a whole spectrum mushroom compounds infused food grade oil; and
infusing a third food grade oil of the food grade oil with the naturally-occurring substance to yield a whole spectrum naturally-occurring substance infused food graded oil;
combining the whole spectrum cannabis compounds infused food grade oil with the whole spectrum naturally-occurring substance infused food grade oil and the whole spectrum mushroom compounds infused food grade oil to yield a combined food grade oil; and
infusing at least one orally ingestible consumable with the combined food grade oil.

2. The method of claim 1, further comprising:
providing the food grade oil at a temperature of 170° F.-240° F.

3. The method of claim 1, wherein infusing the first food grade oil of the food grade oil with the cannabis further comprises:
freezing the cannabis to yield frozen cannabis; and
adding at least a portion of the frozen cannabis to the food grade oil to form a cannabis and food grade oil mixture.

4. The method of claim 3, wherein infusing the food grade oil with the cannabis, the mushroom compound and the naturally-occurring substance further comprises:
heating a mixture to a temperature of 170° F.-240° F. for 4-12 hours, wherein the mixture is one of the cannabis and food grade oil mixture, a mushroom and food grade oil mixture, a naturally-occurring substance and food grade oil mixture and a consumable and infused oil mixture.

5. The method of claim 4, wherein infusing the food grade oil with the cannabis, the mushroom compound and the naturally-occurring substance further comprises:
freezing the mixture into a solid biomass.

6. The method of claim 5, wherein infusing the food grade oil with the cannabis, the mushroom compound and the naturally-occurring substance further comprises:
heating the solid biomass at a temperature of 150° F.-200° F. for 2-4 hours.

7. The method of claim 6, wherein infusing the first food grade oil of the food grade oil with the cannabis further comprises:
straining the heated solid biomass to separate the food grade oil from the cannabis to yield the whole spectrum cannabis compounds infused food grade oil.

8. The method of claim 1, further comprising:
heating the whole spectrum cannabis compounds infused food grade oil to a temperature of 250° F.-300° F. for 1-6 hours.

9. The method of claim 8, further comprising:
cooling the heated whole spectrum cannabis compounds infused food grade oil to a temperature of 150° F.-200° F.

10. The method of claim 4, infusing the at least one orally ingestible consumable with the combined food grade oil further comprises:
adding the at least one orally ingestible consumable to the combined food grade oil to form the consumable and infused oil mixture.

11. A consumable infused with compounds from cannabis, naturally-occurring substances and mushrooms, the consumable comprising:
a combined food grade oil, wherein:
a food grade oil is infused with cannabis, a mushroom compound and a naturally-occurring substance, wherein infusing further comprises:
infusing a first food grade oil of the food grade oil with the cannabis to yield a whole spectrum cannabis compounds infused food grade oil;
infusing a second food grade oil of the food grade oil with the mushroom compound to yield a whole spectrum mushroom compounds infused food grade oil; and
infusing a third food grade oil of the food grade oil with the naturally-occurring substance to yield a whole spectrum naturally-occurring substance infused food graded oil; and
the whole spectrum cannabis compounds infused food grade oil, the whole spectrum naturally-occurring substance infused food grade oil and the whole spectrum mushroom compounds infused food grade oil are combined to yield the combined food grade oil; and
at least one orally ingestible consumable, wherein at least one orally ingestible consumable is infused with the combined food grade oil.

12. The consumable of claim 11, wherein the food grade oil is provided at a temperature of 170° F.-240° F.

13. The consumable of claim 11, wherein infusing the first food grade oil of the food grade oil with the cannabis further comprises:
freezing the cannabis to yield frozen cannabis; and
adding at least a portion of the frozen cannabis to the food grade oil to form a cannabis and food grade oil mixture.

14. The consumable of claim 13, wherein infusing the food grade oil with the cannabis, the mushroom compound and the naturally-occurring substance further comprises:
heating a mixture to a temperature of 170° F.-240° F. for 4-12 hours, wherein the mixture is one of the cannabis and food grade oil mixture, a mushroom and food grade oil mixture, a naturally-occurring substance and food grade oil mixture and a consumable and infused oil mixture.

15. The consumable of claim 14, wherein infusing the food grade oil with the cannabis, the mushroom compound and the naturally-occurring substance further comprises:
freezing the mixture into a solid biomass.

16. The consumable of claim 15, wherein infusing the food grade oil with the cannabis, the mushroom compound and the naturally-occurring substance further comprises:
heating the solid biomass at a temperature of 150° F.-200° F. for 2-4 hours.

17. The consumable of claim 16, wherein infusing the first food grade oil of the food grade oil with the cannabis further comprises:
straining the heated solid biomass to separate the food grade oil from the cannabis to yield the whole spectrum cannabis compounds infused food grade oil.

18. The consumable of claim 11, wherein the whole spectrum cannabis compounds infused food grade oil is heated to a temperature of 250° F.-300° F. for 1-6 hours.

19. The consumable of claim 18, wherein the heated whole spectrum cannabis compounds infused food grade oil gets cooled to a temperature of 150° F.-200° F.

20. The consumable of claim 14, wherein infusing the at least one orally ingestible consumable with the combined food grade oil further comprises:
adding the at least one orally ingestible consumable to the combined food grade oil to form the consumable and infused oil mixture.
